(19) United States
(12) Patent Application Publication
(10) Pub. No.: US 2013/0192356 A1
(43) Pub. Date: Aug. 1, 2013

(54) METHODS AND APPARATUS FOR MEASURING TECHNICAL PARAMETERS OF EQUIPMENT, TOOLS, AND COMPONENTS VIA CONFORMAL ELECTRONICS

(71) Applicants: Bassel De Graff, San Juan (TT); William J. Arora, Bellevue, WA (US); Roozbeh Ghaffari, Cambridge, MA (US); Gilman Callsen, Charlottesville, VA (US); Kevin J. Dowling, Westford, MA (US)

(72) Inventors: Bassel De Graff, San Juan (TT); William J. Arora, Bellevue, WA (US); Roozbeh Ghaffari, Cambridge, MA (US); Gilman Callsen, Charlottesville, VA (US); Kevin J. Dowling, Westford, MA (US)

(73) Assignee: MC10, Inc.

(21) Appl. No.: 13/640,280

(22) PCT Filed: Apr. 7, 2011
(86) PCT No.: PCT/US2011/031648

§ 371 Date: Feb. 25, 2013

Related U.S. Application Data
(63) Continuation-in-part of application No. 12/972,073, filed on Dec. 17, 2010.
Application No. 12/972,073 is a continuation of application No. PCT/US10/51196, filed on Oct. 1, 2010.
(60) Provisional application No. 61/321,648, filed on Apr. 7, 2010.
(60) Provisional application No. 61/287,615, filed on Dec. 17, 2009.
(60) Provisional application No. 61/321,648, filed on Apr. 7, 2010.
(60) Provisional application No. 61/247,933, filed on Oct. 1, 2009.

(51) Int. Cl. G01V 9/00

(52) U.S. Cl. CPC G01V 9/00
USPC 73/152.01

(57) ABSTRACT

A flexible and/or stretchable “test data sheet” is provided for recording technical parameters associated with various industrial equipment. The test data sheet includes a flexible and/or stretchable substrate, a microprocessor disposed on the substrate, a memory disposed on the substrate, a power source disposed on the substrate, and one or more sensors of various types disposed on the substrate (e.g., temperature sensors, photodiodes/imaging sensors, impact/force sensors, accelerometers, etc.). The test data sheet optionally may include one or more ports or communication interfaces to facilitate wired or wireless communication to/from the data sheet. The test data sheet is coupled (e.g., applied to) an arbitrarily-shaped surface associated with a piece of industrial equipment, a tool, a pipe, etc., and the test data sheet conforms to as to facilitate intimate proximity to the surface. In this manner, the test data sheet may be in the form of an electronic sticker or decal. The elastic nature of the test data sheet permits it to accommodate vibrations, stretching, change of shape, etc. Of the surface itself, and harsh conditions associated with same, while nonetheless maintaining the data sheet's electronic functionality.

### CROSS-REFERENCES TO RELATED APPLICATIONS

The present application claims a priority benefit, under 35 U.S.C. §119(e), to U.S. provisional patent application Ser. No. 61/321,648, filed Apr. 7, 2010, entitled “Stretchable Circuits in Non-Medical Applications.”

The present application also claims a priority benefit, under 35 U.S.C. §120, to, as a continuation-in-part (CIP) of, U.S. patent application Ser. No. 12/972,073, filed Dec. 17, 2010, entitled “Methods and Apparatus for Conformal Sensing of Force and/or Acceleration at a Person's Head.”

U.S. patent application Ser. No. 12/972,073 in turn claims a priority benefit, under 35 U.S.C. §119(e), to U.S. provisional patent application Ser. No. 61/287,615, filed Dec. 17, 2009, entitled “Conformal, Helmet-Pad Integrated Blast Dosimeter.”

U.S. patent application Ser. No. 12/972,073 also claims a priority benefit, under 35 U.S.C. §120, to PCT application no. PCT/US2010/051196, filed Oct. 1, 2010, entitled “Protective Cases with Integrated Electronics.”

PCT application PCT/US2010/051196 in turn claims a priority benefit, under 35 U.S.C. §119(e), to U.S. provisional application Ser. No. 61/247,933, filed Oct. 1, 2009, entitled “Protective Polymeric Skins That Detect and Respond to Wireless Signals.”

Each of the above-identified applications is hereby incorporated herein by reference in its entirety.

### BACKGROUND

Technical parameters associated with industrial equipment are often required to be measured and recorded, to ensure smooth operation of the equipment and safety. For example, in hydrocarbon explorations, electronics and sensors are placed downhole along an oil production tubing string. Systems for measuring parameters in a well drilling environment have been described in, for example, U.S. Pat. Nos. 6,679,332 and 7,170,423, the disclosures of which are hereby incorporated by reference in their entirety.

### SUMMARY

Regarding sensing of parameters of industrial equipment and environment (e.g., temperature, pressure, flow rate, etc.), the Inventors have identified various shortcomings in connection with conventional apparatus for sensing such changes.

For example, regarding the use of sensors in connection with drilling equipment, such as measurements-while-drilling (MWD), logging-while-drilling (LWD) or seismic-while-drilling (SWD) as described in the U.S. patents mentioned above, the Inventors have appreciated that sensors placed in a downhole electronics module, may not accurately sense the parameters of the equipment. In particular, such electronics modules are not intimately coupled to the equipment, but rather are shielded from the environment such as the flow of oil and gas. Accordingly, the accuracy of the sensing is reduced, and may include misleading components due to the mechanical coupling (or decoupling) between the electronics module and the equipment. In addition, due to the complex shapes and large differences in sizes of the equipment, the electronics modules often need to be designed specifically for different equipment such as pipes of different shapes and sizes, resulting in a high cost.

In view of the foregoing, the Inventors have recognized and appreciated that both universality and low cost are desirable attributes of techniques for sensing parameters in connection with industrial equipment.

Irrespective of the type and number of sensing elements employed to measure or record parameters of the equipment and/or environment, the Inventors further have appreciated that electronics which substantially conform to arbitrarily-shaped surfaces, such as those typically associated with industrial equipment, would significantly facilitate accuracy and flexibility in sensing important parameters relating to industrial applications, and reduce the cost.

Accordingly, various inventive embodiments disclosed herein relate to methods and apparatus for conformal sensing of parameters.

In illustrative embodiments, sufficiently accurate sensing of parameters at an arbitrarily-shaped surface, such as a surface typically associated with a conduit for a gas or fluid flow, is accomplished by an apparatus including a sensing element disposed on or otherwise integrated with a flexible substrate that substantially conforms to the arbitrarily-shaped surface. In one aspect, the conformable nature of the apparatus facilitates intimate proximity of the apparatus to the surface at which accurate sensing is desired. “Intimate proximity” generally refers to a sufficient mechanical coupling to the arbitrarily-shaped surface without undesirable obstruction (e.g., the apparatus maintains a relatively low profile with respect to the surface), and/or undesirable interference (e.g., from other motion or vibration not related to the surface). In some exemplary implementations discussed herein, intimate proximity is realized as substantial direct contact with the arbitrarily-shaped surface, due to the ability of the apparatus to conform to various contours of the surface.

Examples of significantly contoured and arbitrarily-shaped surfaces contemplated in connection with the inventive concepts disclosed herein, particularly in the context of industrial equipment, include, but are not limited to: complex curvature in air or fluid conduits; and sharply angled features at joints of the conduits. It should be appreciated, however, that notwithstanding the foregoing examples relating primarily to conduits, a wide variety of arbitrarily-shaped surfaces, whether or not associated with an industrial application, are contemplated in connection with the inventive concepts disclosed herein.

In some embodiments, a sensing apparatus may include one or more sensing elements (e.g., a pressure sensor, a thermometer, a flow rate meter) disposed on or integrated with the flexible substrate. Additionally, in some embodiments the apparatus further may include one or more of a processor, a memory, a communication interface and a power source. In one aspect, one or more of the processor, the memory, the communication interface and the power source also may be disposed on or integrated with the flexible substrate. In another aspect, the processor may receive and/or process one or more output signals generated by the sensing element(s) and, in the context of sensing parameters proximate to a surface of a equipment, provide information relating to, for example, temperature, pressure, flow rate, expansion/contraction, and structural integrity. In yet other aspects, the memory may store various data relating to the output signal(s) provided by the sensing element(s), and the communication interface may communicate various information to and/or from the apparatus.

Some inventive embodiments discussed in further detail below relate to a system of a conformal sensing apparatus and one or more output devices to provide perceivable indicators or cues (e.g., audible cues, visual cues) representing parameters requiring immediate attention. For example, in one embodiment, one or more acoustic speakers, and/or one or more light sources, are coupled to a conformal sensing apparatus to provide one or more audible and/or visual cues representing a sudden change in parameters, based at least in part on one or more output signals generated by the sensing apparatus. In one exemplary implementation involving visual cues, multiple light emitting diodes (LEDs) having different colors are employed, wherein different colors of LEDs, when energized, respectively correspond to different degrees of the impact or potential trauma.

To facilitate conformality of a sensing apparatus according to various embodiments disclosed herein, the flexible substrate of a conformal sensing apparatus may be formed of a plastic material or an elastomeric material, including any of a wide variety of polymeric materials. In one embodiment, the flexible substrate is configured as a flexible “tape” (e.g., having a thickness of less than five millimeters) that may have an adhesive disposed on at least one surface of the tape (to render the tape “sticky”). The form factor of an adhesive tape in some implementations facilitates integration of the sensing apparatus with any of a wide variety of equipment and accessories while at the same time ensuring appreciable sensing accuracy and low cost, as discussed in greater detail below.

In some embodiments, one or more of the various functional components of a sensing apparatus according to the inventive concepts disclosed herein may be a commercial off-the-shelf (COTS) component (e.g., a pre-packaged chip) that is disposed on or integrated with the flexible substrate. In other embodiments, one or more functional components may be particularly-fabricated, and disposed on or integrated with the flexible substrate at a die level.

In yet another embodiment, to facilitate the conformal nature of the sensing apparatus, some or all of the functional components disposed on or integrated with the flexible substrate may be electrically coupled to each other using one or more flexible and/or stretchable interconnects. Flexible and/or stretchable interconnects may employ metals (e.g., copper, silver, gold, aluminum, alloys) or semiconductors (e.g., silicon, indium tin oxide, gallium arsenide) that are configured so as to be capable of undergoing a variety of flexions and strains (e.g., stretching, bending, tension, compression, flexing, twisting, torqueing), in one or more directions, without adversely impacting electrical connection to, or electrical conduction from, one or more functional components of the sensing apparatus. Examples of such flexible and/or stretchable interconnects include, but are not limited to, wavy interconnects, bent interconnects, buckled interconnects, and serpentine patterns of conductors.

In one aspect of embodiments relating to industrial equipment, a sensing apparatus for conformal sensing of equipment parameters further may include switching circuitry to detect the proximity of the apparatus to the equipment, so that the apparatus is placed into a particular operational mode (e.g., powered-up) when proximity to the equipment or a flow of gas or fluid is detected. In exemplary implementations, such switching circuitry may include one or more capacitive sensors to detect changes in electric field (e.g., due to an electrical conductivity of a person's skin) so as to sense proximity of the apparatus to the equipment or to a flow of fluid or gas.

In sum, one embodiment of the present invention is directed to a flexible and/or stretchable “test data sheet” for recording technical parameters associated with various industrial equipment. The test data sheet includes a flexible and/or stretchable substrate, a microprocessor disposed on the substrate, a memory disposed on the substrate, a power source disposed on the substrate, and one or more sensors of various types disposed on the substrate (e.g., temperature sensors, photodiodes/imaging sensors, impact/force sensors, accelerometers, etc.). The test data sheet optionally may include one or more ports or communication interfaces to facilitate wired or wireless communication to/from the data sheet. The test data sheet is coupled (e.g., applied to) an arbitrarily-shaped surface associated with a piece of industrial equipment, a tool, a pipe, etc., and the test data sheet conforms to as to facilitate intimate proximity to the surface. In this manner, the test data sheet may be in the form of an electronic sticker or decal. The elastic nature of the test data sheet permits it to accommodate vibrations, stretching, change of shape, etc. of the surface itself, and harsh conditions associated with same, while nonetheless maintaining the data sheet's electronic functionality.

Another embodiment is directed to a method, comprising sensing parameters proximate to a piece of equipment's surface via at least one sensing element disposed on a flexible substrate in sufficient contact with the surface, the flexible substrate substantially conforming to the surface so as to facilitate intimate proximity of the at least one sensing element to the surface, the at least one sensing element including at least one of a pressure sensor, a thermometer, a flow meter, and an accelerometer.

Another embodiment is directed to test data sheet for sensing at least one technical parameter associated with a component during manufacturing, testing, operation and/or use of the component, the test data sheet including a flexible and/or stretchable substrate to substantially conform to a surface of the component so as to facilitate significant proximity of the test data sheet to the surface of the component; an adhesive disposed on at least a portion of the flexible and/or stretchable substrate to facilitate mechanical coupling of the test data sheet to the surface of the component; and electronic circuitry disposed on, and/or formed or embedded in, the flexible and/or stretchable substrate, the electronic circuitry including at least one sensing element to sense the at least one technical parameter and generate at least one output signal based at least in part on the at least one sensed technical parameter; a processor communicatively coupled to the at least one sensing element to receive and process the at least one output signal; a memory communicatively coupled to the processor to store data relating to the at least one output signal; and at least one power source to provide power to at least some of the electronic circuitry, wherein the test data sheet is configured to deform in shape and/or size, in response to changes in physical conditions and/or environmental conditions associated with the surface of the component, without significant degradation to functional performance of the electronic circuitry.

Another embodiment is directed to a system including the test data sheet described above; and the component, wherein the test data sheet is coupled to the component by the adhesive, and wherein the component includes one of: a drilling component; a mining component; a material processing and/or refining component; a construction component; a building component; a manufacturing component; a transportation infrastructure component; a shipping and distribution tracking component; an automotive or other vehicle component; an aerospace component; a medical component; an energy production component; a water treatment component; a waste treatment component; and a chemical processing component.

Another embodiment is directed to a system including the test data sheet of described above; and the component, wherein the component includes one of a container, a duct, a pipe and a conduit.

Another embodiment is directed to a system including the test data sheet of described above; and the component, wherein the component includes one of: a handheld consumer product; a toy; a tool; a camera; a computer; an audio device; a sporting product; an electronic book; a television or display device; a food container; a home appliance; an article of furniture; a video game accessory; and a watch.

Another embodiment is directed to an apparatus, including a manufactured component; and at least one flexible and/or stretchable electronic component, mechanically coupled to a surface of the manufactured component, or at least partially embedded within the manufactured component, for sensing at least one technical parameter associated with the manufactured component during manufacturing, testing, operation and/or use of the manufactured component, the at least one flexible and/or stretchable electronic component including a flexible and/or stretchable substrate; and electronic circuitry disposed on, and/or formed or embedded in, the flexible and/or stretchable substrate, the electronic circuitry including at least one sensing element to sense the at least one technical parameter and generate at least one output signal based at least in part on the at least one sensed technical parameter; a processor communicatively coupled to the at least one sensing element to receive and process the at least one output signal; a memory communicatively coupled to the processor to store data relating to the at least one output signal; and at least one power source to provide power to at least some of the electronic circuitry, wherein the at least one flexible and/or stretchable electronic component is configured to deform in shape and/or size, in response to changes in physical conditions and/or environmental conditions associated with the manufactured component, without significant degradation to functional performance of the electronic circuitry.

Another embodiment is directed to an apparatus, including: a manufactured pipe or duct; and at least one flexible and/or stretchable electronic component, mechanically coupled to a surface of the pipe or duct, or at least partially embedded within the pipe or duct, for sensing at least one technical parameter associated with the pipe or duct, the at least one flexible and/or stretchable electronic component including: a flexible and/or stretchable substrate; and electronic circuitry disposed on, and/or formed or embedded in, the flexible and/or stretchable substrate, the electronic circuitry including: at least one sensing element to sense the at least one technical parameter and generate at least one output signal based at least in part on the at least one sensed technical parameter; a processor communicatively coupled to the at least one sensing element to receive and process the at least one output signal; a memory communicatively coupled to the processor to store data relating to the at least one output signal; and at least one power source to provide power to at least some of the electronic circuitry.

Another embodiment is directed to a stretchable lighting tape, including: a flexible and/or stretchable substrate to substantially conform to an arbitrarily-shaped surface; an adhesive disposed on at least a portion of the flexible and/or stretchable substrate to facilitate mechanical coupling of the stretchable lighting tape to the surface; and electronic circuitry disposed on, and/or formed or embedded in, the flexible and/or stretchable substrate, the electronic circuitry including: a plurality of light emitting diodes (LEDs); and a controller communicatively coupled to the plurality of LEDs to control the LEDs, wherein the stretchable lighting tape is configured to deform in shape and/or size, in response to changes in physical conditions and/or environmental conditions associated with the surface, without significant degradation to functional performance of the electronic circuitry.

The following publications are hereby incorporated herein by reference:
Kim et al., “Stretchable and Foldable Silicon Integrated Circuits,” Science Express, Mar. 27, 2008, 10.1126/science.1154367;
Ko et al., “A Hemispherical Electronic Eye Camera Based on Compressible Silicon Optoelectronics,” Nature, Aug. 7, 2008, vol. 454, pp. 748-753;
Kim et al., “Complementary Metal Oxide Silicon Integrated Circuits Incorporating Monolithically Integrated Stretchable Wavy Interconnects,” Applied Physics Letters, Jul. 31, 2008, vol. 93, 044102;
Kim et al., “Materials and Noncoplanar Mesh Designs for Integrated Circuits with Linear Elastic Responses to Extreme Mechanical Deformations,” PNAS, Dec. 2, 2008, vol. 105, no. 48, pp. 18675-18680;
Meitl et al., “Transfer Printing by Kinetic Control of Adhesion to an Elastomeric Stamp,” Nature Materials, January, 2006, vol. 5, pp. 33-38;
U.S. publication no. 2010 0002402-A1, published Jan. 7, 2010, filed Mar. 5, 2009, and entitled “STRETCHABLE AND FOLDABLE ELECTRONIC DEVICES;”
U.S. publication no. 2010 0087782-A1, published Apr. 8, 2010, filed Oct. 7, 2009, and entitled “CATHETER BALLOON HAVING STRETCHABLE INTEGRATED CIRCUITRY AND SENSOR ARRAY;”
U.S. publication no. 2010 0116526-A1, published May 13, 2010, filed Nov. 12, 2009, and entitled “EXTREMELY STRETCHABLE ELECTRONICS;”
U.S. publication no. 2010 0178722-A1, published Jul. 15, 2010, filed Jan. 12, 2010, and entitled “METHODS AND APPLICATIONS OF NON-PLANAR IMAGING ARRAYS;” and
U.S. publication no. 2010 027119-A1, published Oct. 28, 2010, filed Nov. 24, 2009, and entitled “SYSTEMS, DEVICES, AND METHODS UTILIZING STRETCHABLE ELECTRONICS TO MEASURE TIRE OR ROAD SURFACE CONDITIONS.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

The foregoing and other aspects, embodiments, and features of the present teachings can be more fully understood from the following description in conjunction with the accompanying drawings.

### BRIEF DESCRIPTION OF THE DRAWINGS

The skilled artisan will understand that the figures, described herein, are for illustration purposes only. It is to be understood that in some instances various aspects of the invention may be shown exaggerated or enlarged to facilitate an understanding of the invention. In the drawings, like reference characters generally refer to like features, functionally similar and/or structurally similar elements throughout the various figures. The drawings are not necessarily to scale, emphasis instead being placed upon illustrating the principles of the teachings. The drawings are not intended to limit the scope of the present teachings in any way.

FIG. 1 illustrates an apparatus for conformal sensing of a technical parameter proximate to a pipe, according to one embodiment of the present invention.

FIG. 2 illustrates a cross-section profile of the apparatus of FIG. 1 configured as a flexible tape, according to one embodiment of the present invention.

FIG. 3 illustrates a top view of the apparatus of FIG. 1 configured as a test data sheet in which one or more functional components may be electrically connected by one or more flexible and/or stretchable interconnects, according to one embodiment of the present invention.

FIG. 4 illustrates the apparatus of FIG. 1 configured as a stretchable band that may be fit to outer or inner surfaces pipes of different sizes, according to one embodiment of the present invention.

FIG. 5 illustrates an exemplary test data sheet of FIG. 3 conforming to arbitrary shapes, according to one embodiment of the present invention.

FIG. 6 is a functional block diagram of the apparatus of FIG. 1, according to one embodiment of the present invention.

FIGS. 7A and 7B illustrate a circuit diagram of the sensing apparatus of FIG. 1 corresponding to the block diagram of FIG. 6, according to one embodiment of the present invention.

FIG. 8 is a flowchart illustrating a method for conformal sensing, according to one embodiment of the present invention.

FIG. 9 is a schematic depiction of various embodiments of the invention.

FIG. 10 is a schematic depiction of an extremely stretchable interconnect.

FIG. 11 illustrates a stretchable electronics component utilized to improve industrial products used in raw material extraction.

FIG. 12 illustrates a stretchable electronics component utilized to improve industrial products used in a processing industry.

FIG. 13 illustrates a stretchable electronics component utilized to improve industrial products used in construction.

FIG. 14 illustrates a stretchable electronics component utilized to improve industrial products used in various manufacturing industries.

FIG. 15 illustrates a stretchable electronics component utilized to improve monitoring of shipment conditions/environment of a product.

FIG. 16 illustrates a stretchable electronics component utilized in various industries.

FIG. 17 illustrates a stretchable electronics component integrated in various devices associated with energy production.

FIG. 18 illustrates a stretchable electronics component utilized with a monitoring device.

FIG. 19 illustrates a stretchable electronics component utilized to improve equipments used in a chemical processing plant.

FIG. 20 illustrates a stretchable electronics component utilized to improve automotive products.

FIG. 21 illustrates a stretchable electronics component utilized to improve monitoring of storage conditions.

### DETAILED DESCRIPTION

Following below are more detailed descriptions of various concepts related to, and embodiments of, inventive methods and apparatus for conformal sensing of force and/or change in motion. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

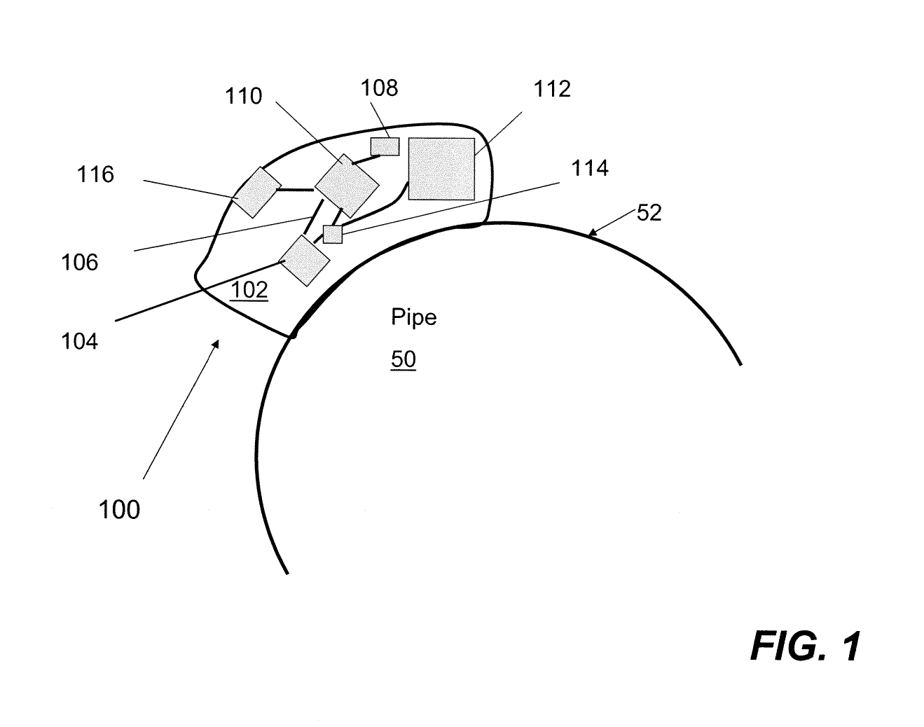

FIG. 1 illustrates an apparatus 100 for conformal sensing of technical parameters proximate to a pipe 50 (not drawn to scale), according to one embodiment of the present invention. The apparatus 100 comprises a flexible substrate 102 that facilitates a sufficient mechanical coupling of the apparatus 100 to a surface 52 of the pipe 50. In one aspect, the conformality of the apparatus provided at least in part by the flexible substrate 102 facilitates intimate proximity to the surface 52 to ensure accurate sensing of technical parameters in connection with the pipe 50. As noted above, “intimate proximity” generally refers to a sufficient mechanical coupling to a surface (e.g., the surface 52) without undesirable obstruction (e.g., the apparatus 100 maintains a relatively low profile with respect to the surface 52), undesirable interference (e.g., from other motion or vibration not related to the surface 52), and/or compromise to accuracy. In some exemplary implementations discussed herein, and as shown for purposes of illustration in FIG. 1, intimate proximity may be realized as substantial direct contact with the surface 52, due to the ability of the apparatus to conform to various contours of the surface (e.g., based at least in part on the flexible substrate 102).

In the embodiment shown in FIG. 1, the flexible substrate 102 may include a plastic material or an elastomeric material. More generally, examples of materials suitable for purposes of the flexible substrate 102 include, but are not limited to, any of a variety of polyimides, polyesters, a silicone or siloxane (e.g., polydimethylsiloxane or PDMS), a photo-patternable silicone, an SU8 polymer, a PDS polydustrene, a parylene, a parylene-N, an ultrahigh molecular weight polyethylene, a polyether ketone, a polyurethane, a polyactic acid, a polyglycolic acid, a polytetrafluoroethylene, a polyamic acid, a polymethyl acrylate, and other polymers or polymer composites.

The apparatus 100 shown in the embodiment of FIG. 1 further includes one or more sensing elements 104, disposed on or otherwise integrated with the flexible substrate 102, to sense a technical parameter (e.g., a force, a physical dimension, a temperature or other environmental parameters, a stress, a strain, a flow rate, a vibration shock). Examples of the sensing element(s) 104 include but are not limited to: a pressure sensor, an accelerometer, a load cell, a temperature sensor, a humidity sensor, a chemical sensor, an optical sensor, an electrical sensor, a piezoelectric sensor, an acoustic sensor, an ultrasonic sensor, a flow rate sensor, and an image sensor. In some other examples, the sensing element includes at least one of a microelectromechanical system (MEMS) device, a complimentary metal oxide semiconductor (CMOS) device, or a CMOS active pixel imaging array.

The sensing element(s) 104 generate one or more output signals 106 (e.g., representing sensed parameters).

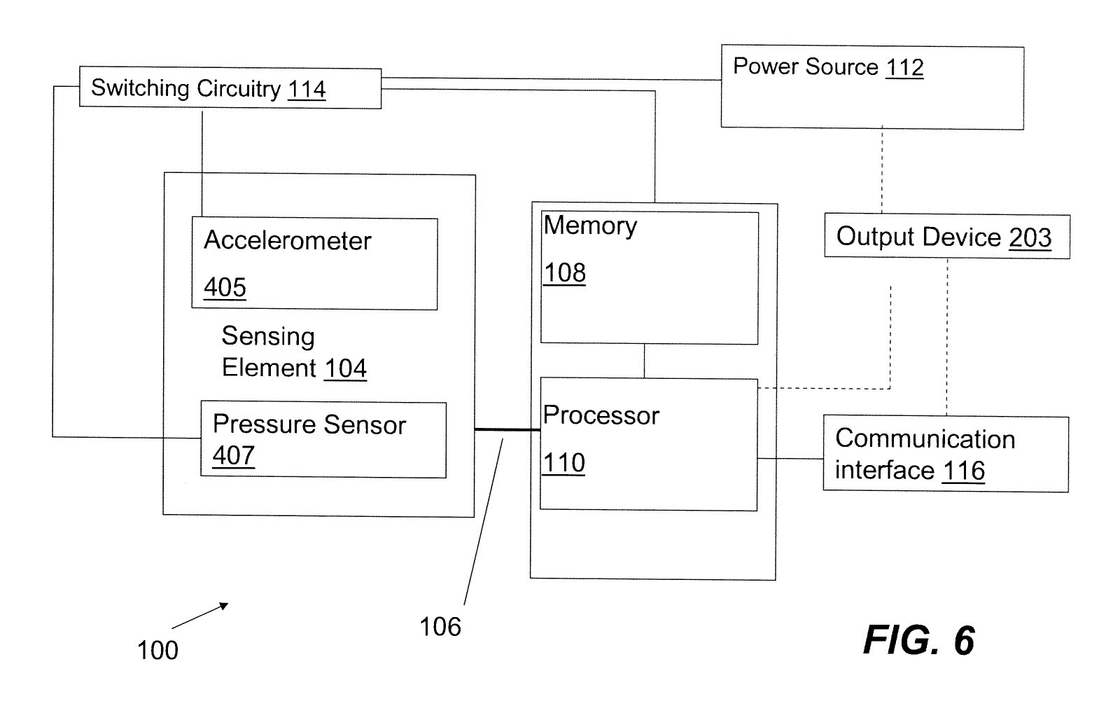

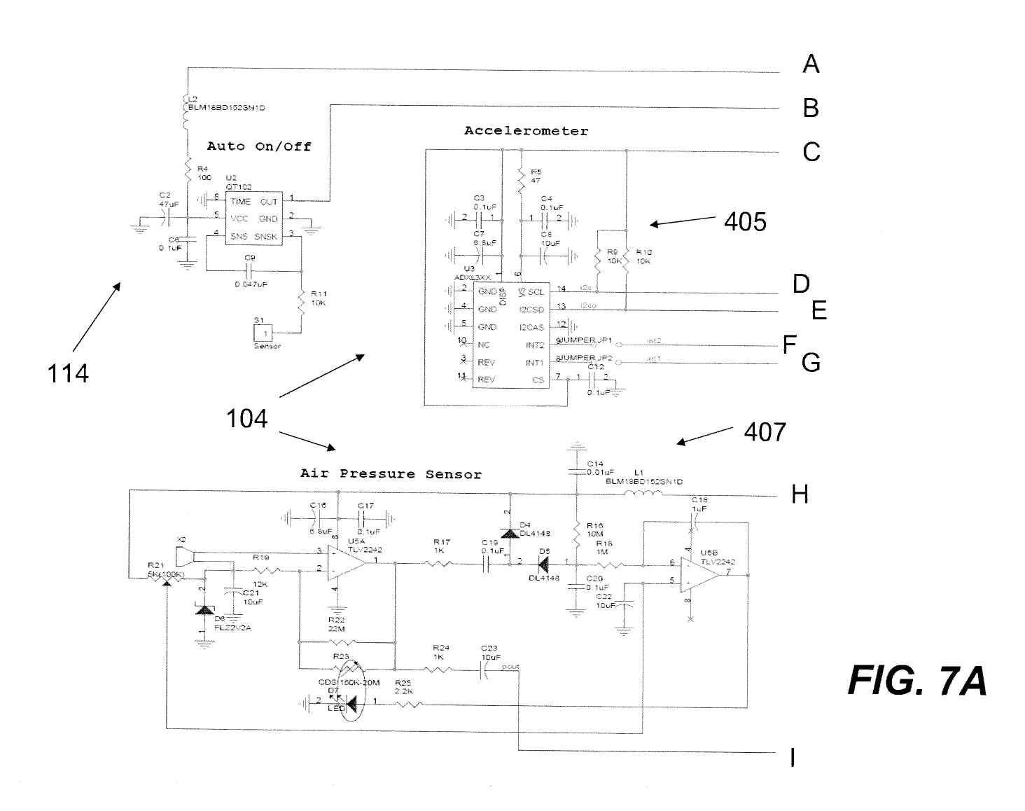

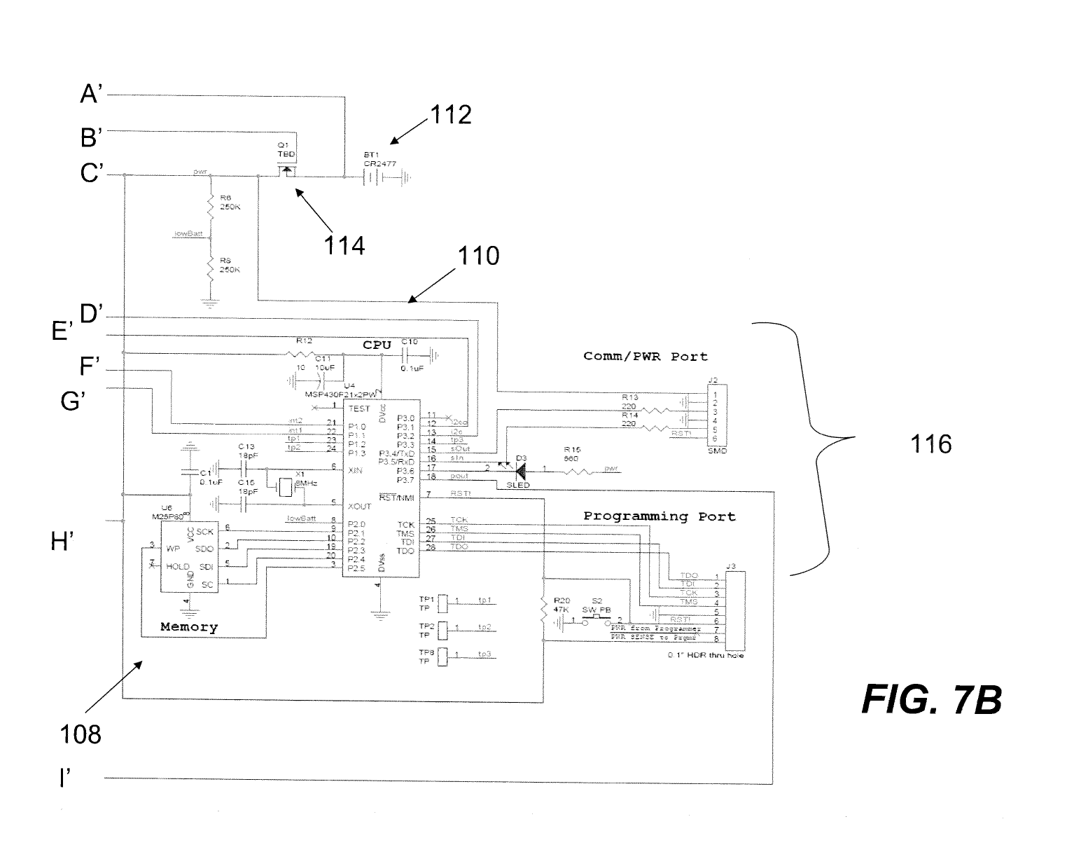

As shown in FIG. 1, the apparatus 100 also may include a processor 110 to receive the output signal(s) 106 generated by the sensing element(s) 104, a memory 108 (e.g., to store data relating to the output signal(s) 106), a communication interface 116 (e.g., to communicate information to and/or from the apparatus 100) and a power source 112 (e.g., to provide power to one or more components of the apparatus 100). The apparatus also may include switching circuitry 114, electrically coupled to the power source 112, to detect a proximity of the apparatus 100 to the pipe 50 or to a presence of a flow of gas or fluid therein, and to electrically couple and/or decouple the power source 112 and at least the processor 110, based at least in part on the detected proximity of the apparatus to the pipe 50. Additional details relating to these various components are discussed below, for example in connection with FIGS. 6, 7A and 7B. Although FIG. 1 illustrates that all of these components may be disposed on or otherwise integrated with the flexible substrate 102, it should be appreciated that in other embodiments, one or more of the components other than the sensing element(s) 104 need not necessarily be disposed on or otherwise integrated with the flexible substrate 102.

It is noted that although a partial cross section of a pipe 50 is illustrated in FIG. 1, the apparatus 100 can be applied to other components such as a container, a duct, a conduit, etc. In addition, the apparatus 100 can cover a partial or whole outer perimeter, or be disposed inside the pipe 50, such as conforming to, mechanically coupled to, or at least partially exposed on, an inner surface of the pipe 50. The flexible and/or stretchable electronic apparatus is configured to deform in shape and/or size, in response to changes in physical conditions and/or environmental conditions associated with the pipe or duct, without significant degradation to functional performance of the electronic circuitry. The pipe or duct is configured to contain and/or conduct at least one substance, and wherein the at least one technical parameter relates at least in part to the at least one substance contained and/or conducted by the pipe or duct.

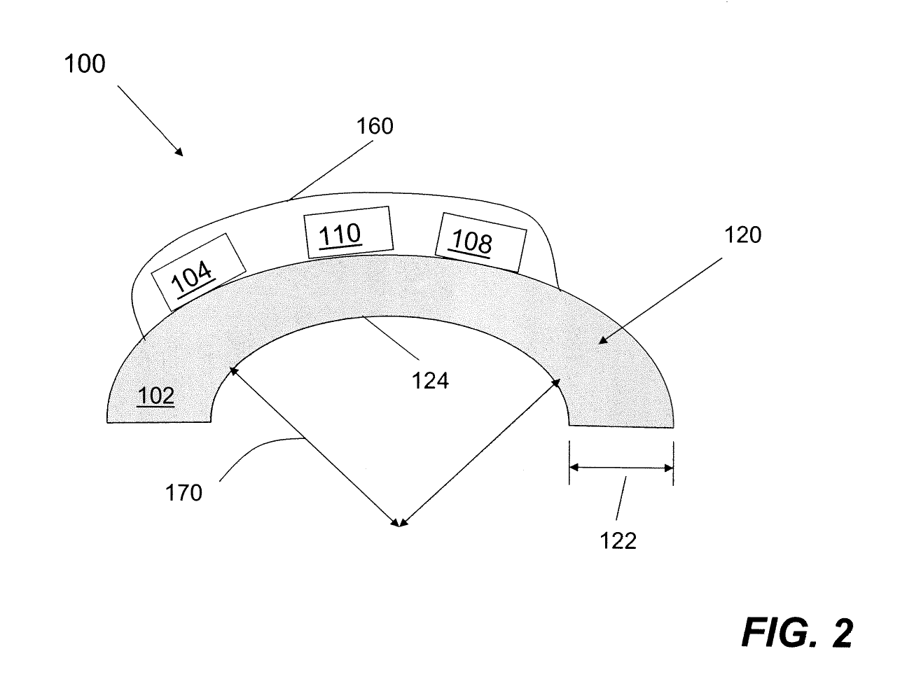

FIG. 2 illustrates a cross-section profile of the apparatus 100 of FIG. 1, according to one embodiment of the invention, wherein the apparatus is configured as a flexible tape 120. Due to the illustrative cross-sectional view, not all of the components shown in FIG. 1 are visible in FIG. 2—for purposes of illustration, only the sensing element(s) 104, the processor 110, and the memory 108 are illustrated as disposed on the flexible substrate 102, which is formed as a flexible tape 120. FIG. 2 also shows that the apparatus 100 may include an encapsulant 160 to encapsulate at least the sensing element(s) 104, and optionally other components of the apparatus as well. Regarding suitable encapsulants, generally one or more of the various materials discussed above that may employed for the flexible substrate 102 also may serve as the encapsulant 160.

In the embodiment of FIG. 2, the flexible tape 120 may be formed of any of the materials noted above in connection with the flexible substrate 102. In one aspect, the flexible tape 120 may be configured to have a thickness 122 on the order of approximately five millimeters or less. In another aspect, the thin flexible nature of the tape 120 provides for a significant bending radius 170 of the apparatus 100 to facilitate conformality to a variety of surface contours; for example, in one implementation, the apparatus 100 based on a flexible tape 120 may have a bending radius 170 in a range of approximately one centimeter to four centimeters. In yet another aspect, the flexible tape 120 may have an adhesive disposed on at least one surface 124 of the tape to render the tape “sticky” (so as to facilitate coupling of the flexible tape 120 to various surfaces). In yet another aspect, the flexible tape 120 may be configured, together with other components of the apparatus 100, to weigh on the order of one ounce or less.

Although FIG. 2 illustrates an example of the apparatus 100 in the form of a flexible tape 120, it should be appreciated that embodiments of the present invention are not limited in this respect. In general, the apparatus 100 may be implemented in a variety of form factors involving a flexible substrate, and having a variety of shapes and dimensions.

In some exemplary implementation of the embodiments shown in FIGS. 1 and 2, one or more of the various functional components of the sensing apparatus 100 (e.g., the sensing element(s) 104, the processor 110, the memory 108, the communication interface 116, etc.) may be a “commercial off-the-shelf” (COTS) component (e.g., a pre-packaged chip) that is disposed on or integrated with the flexible substrate 102. In particular, as discussed further below in connection with FIGS. 7A and 7B, in some implementations a particular COTS component may be single chip package that implements the combined functionality of one or more types of sensors, the processor, and/or the memory. Similarly, some COTS components may include amplifying circuitry, analog-to-digital conversion components, and/or other logic and circuit components. In other implementations, one or more functional components may be particularly-fabricated, and disposed on or integrated with the flexible substrate 102, for example, at a die level.

In view of the foregoing, it should be appreciated that not only does the conformality of the flexible substrate 102 of the apparatus 100 facilitate intimate proximity with the surface 52 of the head 50 (or other surface of interest in connection with which force and/or change of motion sensing is desired); additionally, in some examples, discrete functional elements in the form of COTS components or particularly-fabricated dies of sufficiently small size permit an appreciably small “footprint” of the apparatus 100 so as to facilitate conformality and sufficient mechanical coupling to a surface of interest. In at least some embodiments disclosed herein, a single sensing element (e.g., a thermometer), in some instances packaged together in a single COTS component with one or more of a processor, memory and other supporting circuitry, may be disposed on or otherwise integrated with the flexible substrate 102 to provide a conformal sensing apparatus having an appreciably small size (footprint).

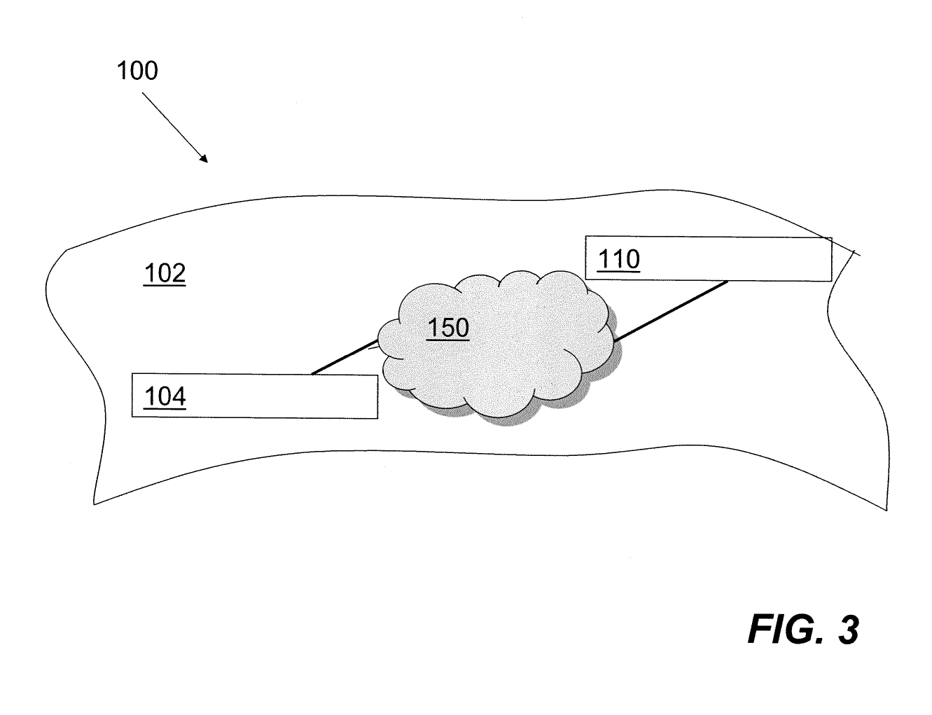

FIG. 3 illustrates a top view of the apparatus 100 of FIG. 1, according to another embodiment of the present invention, in which one or more functional electrical components of the apparatus (e.g., the sensing element(s) 104 and the processor 110) may be electrically connected by one or more flexible and/or stretchable interconnects 150. In one aspect of this embodiment, the use of flexible and/or stretchable interconnects 150 to electrically couple various components, together with the flexible substrate 102, may significantly enhance the conformal nature of the sensing apparatus 100.

Flexible and/or stretchable interconnects 150 may employ metals (e.g., copper, silver, gold, aluminum, alloys) or semiconductors (e.g., silicon, indium tin oxide, gallium arsenide) that are configured so as to be capable of undergoing a variety of flexions and strains (e.g., stretching, bending, tension, compression, flexing, twisting, torqueing), in one or more directions, without adversely impacting electrical connection to, or electrical conduction from, one or more functional components of the apparatus 100. Examples of such flexible and/or stretchable interconnects include, but are not limited to, wavy interconnects, bent interconnects, buckled interconnects, and serpentine patterns of conductors (the flexible and/or stretchable interconnects 150 are illustrated in FIG. 3 as a generalized cloud, as a wide variety of form factors are possible). In various configurations, the flexible and/or stretchable interconnects 150 may be stretchable, for example, up to at least 300%. Additional details of various examples of flexible and/or stretchable interconnects 150 are provided in U.S. publication no. 2010 0002402-A1, published Jan. 7, 2010, filed Mar. 5, 2009, and entitled “STRETCHABLE AND FOLDABLE ELECTRONIC DEVICES,” as well as other published references incorporated herein by reference (e.g., see SUMMARY section above).

In some embodiments, the apparatus 100 is configured as a stretchable lighting tape, including a flexible and/or stretchable substrate to substantially conform to an arbitrarily-shaped surface, an adhesive disposed on at least a portion of the flexible and/or stretchable substrate to facilitate mechanical coupling of the stretchable lighting tape to the surface, and electronic circuitry disposed on, and/or formed or embedded in, the flexible and/or stretchable substrate, the electronic circuitry including a plurality of light emitting diodes (LEDs) such as organic LEDs (OLEDs); and a controller communicatively coupled to the plurality of LEDs to control the LEDs, wherein the stretchable lighting tape is configured to deform in shape and/or size, in response to changes in physical conditions and/or environmental conditions associated with the surface, without significant degradation to functional performance of the electronic circuitry.

In connection with various embodiments disclosed herein, one or more coupling mechanisms may be employed to mechanically couple the apparatus 100 shown in FIGS. 1-3 to a surface of interest (e.g., a part of a piece of equipment, such as a pipe) at which forces and/or changes in motion are to be sensed. In various examples, such a coupling mechanism preferably facilitates a sufficient mechanical coupling to the surface/object of interest to ensure accurate sensing of the parameters. As noted above, in some embodiments the apparatus 100 may be coupled to or otherwise integrated with various equipment, tools, or components to accurately sense technical parameters associated with a pipe 50, as well as other equipment, tools, and components. In this context, as discussed above in connection with FIG. 2, an apparatus 100 including a flexible substrate 102 configured as a flexible tape 120 with an adhesive surface 124 may be integrated with various protective garments or accessories, wherein the adhesive surface 124 of the flexible tape 120 serves at least in part as the coupling mechanism for the apparatus.

After some period of time during which the apparatus 100 has been operating on or inside the pipe and recording data relating to sensed parameters, the apparatus 100 can be easily removed from the pipe 50, and opened to expose the communication interface 116 of the apparatus so as to access stored data. Alternatively, data stored in the apparatus 100 may be transmitted wirelessly to an external device (e.g., via a communication interface configured for wireless communication) for analysis/processing, as discussed further below in connection with FIGS. 6, 7A and 7B.

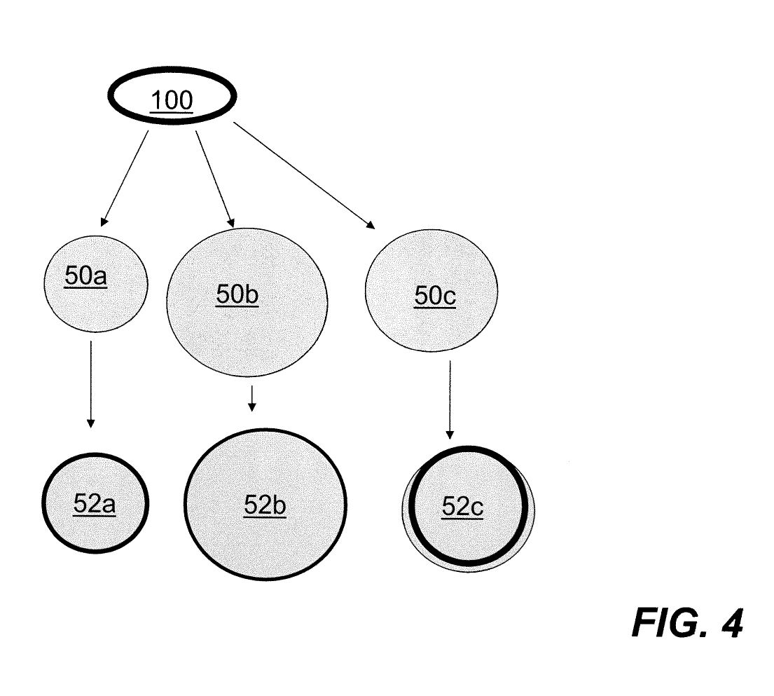

As illustrated in FIG. 4, an apparatus 100 having a rubber-band shape can fit to outer perimeter of pipes 50a, 50b of different sizes, or inner perimeter of a pipe 50c, resulting in pipes 52a, 52b, 52c with expanded functionality of testing.

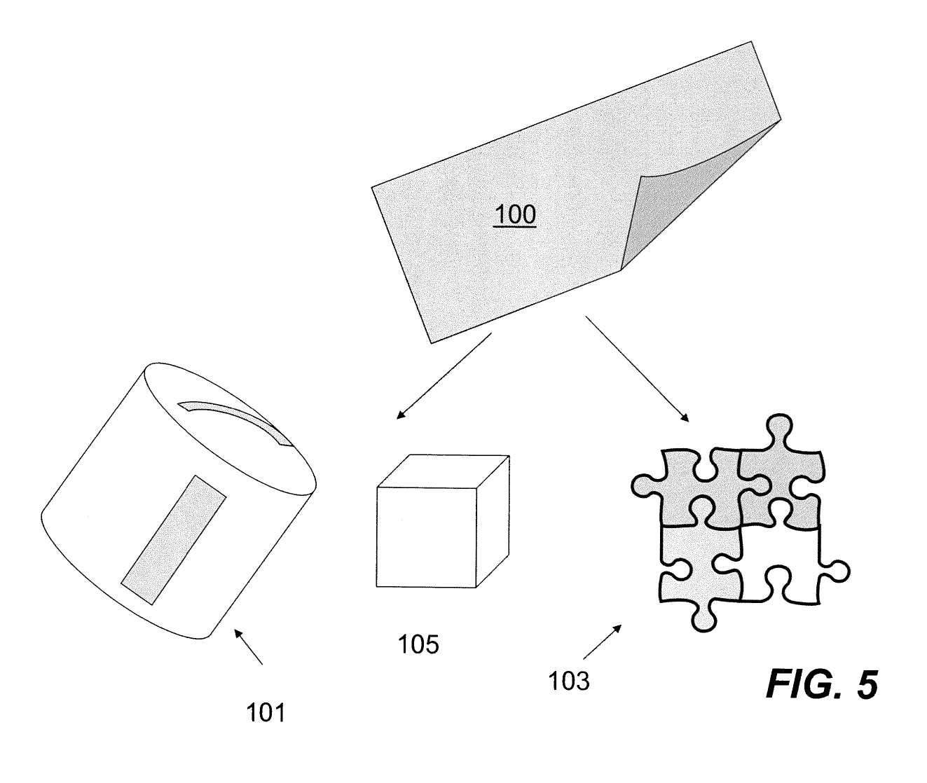

In another embodiment as illustrated in FIG. 5, an apparatus 100 can conform to an industrial tool or component 101, 105, or to a toy 103 of arbitrary shape. In one example, one or a plurality of flexible and/or stretchable electronic components 100 can be distributed along the outer surface and/or the inner surface of the pipe or duct 101, and configured as a sensing sheet disposed along a length of the pipe or duct. The pipe or duct 101 can contain at least one substance such as a fluid, a gas, or solid powder, and the at least one flexible and/or stretchable electronic component senses the at least one technical parameter associated with the substance such as the fluid contained and/or conducted by the pipe or duct. The apparatus 100 can sense at least one technical parameter relates to the pipe or duct according to some embodiments. The sensing element can include an array of imaging devices or acoustic devices such as ultrasound devices, for example. The processor can be configured to control the array of imaging devices to acquire at least one image of the surface of the pipe or duct, and the at least one output signal includes a plurality of output signals representing the at least one image of the surface of the pipe or duct.

In one embodiment, the at least one flexible and/or stretchable electronic apparatus 100 is mechanically coupled to, or at least partially exposed on, an inner surface of the pipe or duct so as to acquire the at least one image of the inner surface of the pipe or duct. In some examples, the pipe or duct includes at least one joint or weld, and wherein the at least one flexible and/or stretchable electronic component is mechanically coupled to the surface of the pipe or duct, or at least partially embedded within the pipe or duct, so as to facilitate inspection or monitoring of the at least one joint or weld. In some embodiments, the pipe or duct includes at least one crack or defect (not shown), and wherein the at least one technical parameter sensed by the flexible and/or stretchable electronic component relates to the at least one crack or defect. The surface of the pipe or duct can be an arbitrarily-shaped non-planar surface, and the at least one flexible and/or stretchable electronic apparatus substantially conforms to the arbitrarily-shaped non-planar surface. The surface of the pipe or duct can be a deformable surface, and wherein the at least one flexible and/or stretchable electronic component is configured to substantially adapt to time-varying physical changes of the deformable surface. The at least one flexible and/or stretchable electronic component can be mechanically coupled to the surface of the pipe or duct, or at least partially embedded within the pipe or duct, so as to fill one or more cracks or defects in the pipe or duct in a self-healing manner.

FIG. 6 is a functional block diagram of the sensing apparatus 100 of FIG. 1, according to one embodiment of the present invention. FIG. 6 shows various functional components indicated in FIG. 1 (e.g., the sensing element(s) 104, the processor 110, the memory 108, the communication interface 116, the power source 112 and the switching circuitry 114), and indicates in greater detail that the sensing element(s) 104 may include an accelerometer 405 and/or a pressure sensor 407. As discussed immediately above, FIG. 6 also shows that a system based on the sensing apparatus 100 may include one or more output devices 203 to provide one or more perceivable indicators or cues (e.g., audible cues, visual cues) representing impact or trauma, based on forces and/or changes in motion sensed by the apparatus 100. In different implementations, as indicated by the dotted lines in FIG. 6, the output device(s) 203 may be coupled to the power source 112 (or receive power from a different source), and may be communicatively coupled to the processor 110 (e.g., either directly and/or via the communication interface 116).

FIGS. 7A and 7B illustrate a circuit diagram of the sensing apparatus of FIG. 1 corresponding to the block diagram of FIG. 6, according to one embodiment of the present invention. The various functional blocks indicated in FIG. 6 are mapped generally to corresponding circuit elements in FIGS. 7A and 7B. It should be appreciated that the circuit diagram shown in FIGS. 7A and 7B provides merely one implementation example of an apparatus and system based on the block diagram of FIG. 6, and that other implementations are possible according to other embodiments.

With reference to both FIG. 6 and FIG. 7A, regarding the sensing element(s) 104, in exemplary implementations the pressure sensor 407 may be an air pressure transducer, and in some instances an omni-directional air pressure sensor may be employed. In the case of a dynamic air pressure transducer, such a transducer may have a significant dynamic range (e.g., to sense pressure changes from whispers to blasts of explosive devices), represented by output signals 106 having a signal level in a range of from approximately 60 dB to 170 dB. Exemplary pressures represented by the output signal of a dynamic pressure transducer may be in a range of from approximately 4 pounds/square inch (PSI) to 100 PSI.

As shown in FIG. 7A, the pressure sensor 407 may include various circuitry associated with a pressure transducer, to condition signals generated by the transducer. For example, the associated circuitry may include an automatic gain control (AGC) amplifier, an analog-digital converter, and an adjustable resister to adjust a gain of the AGC amplifier. For example, the AGC range can be over 60 dB and the maximum gain can be set by a 22 MΩ resistance across the AGC amplifier (U5A). The resistor (R25) shown in FIG. 7A in series with the LED of the opto-coupler (D7, R23) dynamically adjusts the sensitivity of the AGC, by adjusting the current flowing through the opto-coupler based upon the output voltage of USB. Adjusting the current changes the brightness of the LED (D7), and in turn the resistance of variable resistor R23, which in parallel with R22, adjusts the gain of the AGC amplifier. The value of R22 (e.g., 22 MΩ) may be increased (to decrease the nominal gain of the AGC amplifier) if the feedback loop is unstable. The response time of the AGC feedback loop is sufficiently fast and the transducer allows for adjustment-free pressure sensing, even during an explosion (e.g., IED blast). With the wiper of bias resistor R21 set at 40K/60K (in a range of 0-100K) the sensing range of the pressure transducer is on the order of 4-100 PSI. The sensing range of the pressure transducer can be adjusted by changing the wiper position of R21. In various implementations, signal conversion between sound levels (dB) and PSI may be accomplished by the processor 110, or output signals from the pressure sensor may be transmitted to an external device (e.g., via the communication interface 116) for conversion of electrical signals to pressure levels (e.g., 100 PSI equals 170 dB, 50 PSI equals 132 dB, 4 PSI equals 89 dB).

In one aspect the sensor 405 may generate an analog output signal 106, and the analog-to-digital (A/D) conversion of the output signal 106 may take place elsewhere (e.g., in the processor 110, or in an external device); in another aspect, the accelerometer 405 may include integrated A/D conversion and provide a digital output signal 106.

As discussed above, the switching circuitry 114, portions of which are shown in both FIGS. 7A and 7B, is coupled to the power source 112 (e.g., see the battery BT1 in FIG. 7B) and electrically couples and/or decouples the power source and one or more other components of the apparatus 100. In one embodiment, the switching circuitry couples and decouples power to/from various components based on a detected proximity to a surface of interest for which sensed parameters are desired (e.g., a pipe surface). To this end, the switching circuitry may include one or more capacitive probes to detect a change in an electric field so as to detect the proximity of the apparatus to the pipe surface or content (e.g., gas, fluid) therein. In particular, in some implementations, one or more capacitive probes detect an electrical conductivity of metal at the surface of the pipe so as to detect the proximity of the apparatus to the pipe.

With reference to the exemplary circuit diagram shown in FIGS. 7A and 7B, the switching circuitry 114 may be implemented by a “single key chip” given by the QTouch™ chip QT102 manufactured by Quantum Research Group (shown as U2 in FIG. 7A). This chip ultimately controls transistor Q1 (see FIG. 7B) to couple power provided by power source 112 (e.g., battery BT1) to the processor 110, the memory 108, and other components of the apparatus 100. A capacitive probe (see Sensor S1 in FIG. 7A) provides an input to the chip U2 based on detecting changes in electric field (e.g., associated with the conductivity of skin as the apparatus is placed in proximity to a skin surface). The change in electric field thus provides a ‘touch-on/touch-off’ toggle mode for the switching circuitry 114. The circuitry 114 also may include other components (e.g., capacitors, resistors, and inductors) relating to timeout and timing override features.

As shown in FIG. 7B, the processor 110 and memory 108 may be implemented as respective COTS chips having any of a variety of appropriate features. In one exemplary implementation, the processor 110 can be a microcontroller unit (MCU) with the following specifications: Core Size 16-Bit; Program Memory Size 4 KB (4K×8+256B); Program Memory Type FLASH; Connectivity SPI, UART/USART; Peripherals Brown-out Detect/Reset, POR, PWM, WDT; RAM Size 256×8; Speed 8 MHz; Number of I/O 22; Oscillator Type Internal; Data Converters A/D 8×10b. Similarly, in one exemplary implementation, the memory 108 may have the following specifications: Memory Type FLASH; Memory Size 8 Mb (1 Mb×8); Speed 75 MHz; Interface SPI, 3-Wire Serial; Voltage—Supply 2.7 V˜3.6 V.

Regarding the communication interface 116 shown in FIG. 7B, in one example the communication interface may essentially be constituted by one or more ports providing connectivity to the processor 110. For example, the communication interface 116 may include a “programming port” for providing information to the processor 110, and a “Comm/PWR port” for connecting the power source 112 to one or more external devices, as well as providing two-wire transmit and receive signal capabilities to and from the processor 110 (see TxD pin 15 and RxD pin 16 of the processor 110).

More generally, it should be appreciated that the communication interface 116 may be any wired and/or wireless communication interface by which information may be exchanged between the apparatus 100 and an external or remote device, such as a remote computing device. Examples of wired communication interfaces may include, but are not limited to, USB ports, RS232 connectors, RJ45 connectors, and Ethernet connectors, and any appropriate circuitry associated therewith. Examples of wireless communication interfaces may include, but are not limited to, interfaces implementing Bluetooth® technology, Wi-Fi, Wi-Max, IEEE 802.11 technology, radio frequency (RF) communications, Infrared Data Association (IrDA) compatible protocols, Local Area Networks (LAN), Wide Area Networks (WAN), and Shared Wireless Access Protocol (SWAP).

Regarding the power source 112, in one exemplary implementation the power source may be a battery with the following specifications: Family Lithium; Series CR2477; Battery Cell Size Coin 24.5 mm; Voltage—Rated 3V; Capacity 660 mAh. In one example, the total power draw for the apparatus is configured to be approximately 67 μA per hour (assuming a 1 MHz sampling rate of the output signal 106 by the processor 110, with a 14-bit resolution). For an estimated average ‘ON’ time of about 20 hours per day, the battery life in this case would be about 41 days (in the event that the apparatus is stuck ‘ON’ for 24 hours per day, it will still last for 34 days with the foregoing exemplary ratings; also, if the sampling rate is decreased to <40 kHz, the battery size can be reduced even further).

Regarding the functionality of the processor 110 in exemplary embodiments, with reference to FIGS. 6, 7A and 7B, the processor 110 receives the output signal(s) 106 from the sensing element(s) 104 and, based on same, provides information relating to the sensed parameters represented by the output signal(s).

More specifically, in one embodiment, the processor is configured to implement particular functionality via execution of processor-executable instructions stored in the memory 108, and/or internal memory of the processor 110. In one aspect, pursuant to executed instructions, the processor compares the sensed force and/or the change in motion represented by the output signal(s) 106 to at least one “trigger value” so as to provide the information relating to the possible injury/trauma. In various aspects, the trigger value(s) may represent one or more threshold values corresponding to parameters representing some type of events. For example, in one case, the trigger value(s) may represent an onset of a flow inside a pipe.

In other aspects, one or more trigger values may be stored in the memory 108, and/or one or more trigger values may be received via the communication interface 116 (e.g., via the programming port shown in FIG. 7B) to facilitate downloading of a variety of trigger values based on different contexts/environments in which the apparatus 100 is to be employed. In another aspect, information provided by the processor 110 relating to the possible injury/trauma itself may be stored in the memory 108. In particular, one or more sampled and digitized output signals 106 themselves may be stored in the memory 108 for analysis/processing. To this end, the processor may be configured to sample the output signal(s) at a frequency up to approximately 1 MHz (e.g., so as to provide adequate sampling of parameters over time), and converts sampled analog signals to digital values via analog-to-digital conversion (e.g., in one example, the processor implements A/D conversion having a 14-bit resolution).

With reference again to FIGS. 6 and 7B, although not shown explicitly in FIG. 7B, one or more output devices 203 may be coupled to the “Comm/PWR Port” of the circuit shown in FIG. 7B to receive control signals from the processor 110, and optionally power from the power source 112 (alternatively, the output device(s) 203 may include their own power sources). As noted above, in one embodiment, one or more acoustic speakers, and/or one or more light sources (e.g., LEDs), may be coupled as output devices 203 to the apparatus (e.g., and particularly to the processor 110) to provide one or more audible and/or visual cues representing impact or trauma. More specifically, based at least in part on one or more output signals generated by the sensing apparatus and provided as input to the processor 110, the processor in turn generates one or more control signals to appropriately control the output device(s) so as to provide indications based on sensed parameters. In some implementations, the output device(s) 203 may be implemented as part of the apparatus 100 itself, or as a separate entity. Details regarding the integration of acoustic speakers and/or LEDs with a flexible substrate, which may be useful for some embodiments according to the present invention, are described in PCT application no. PCT/US2010/051196, filed Oct. 1, 2010, entitled “Protective Cases with Integrated Electronics,” and U.S. provisional application Ser. No. 61/247,933, filed Oct. 1, 2009, entitled “Protective Polymeric Skins That Detect and Respond to Wireless Signals,” both of which applications are incorporated by reference herein in their entirety.

In one exemplary implementation involving visual cues, multiple light emitting diodes (LEDs) having different colors are employed, wherein different colors of LEDs, when energized, respectively correspond to different levels of sensed parameters (e.g., red=high flow rate; orange: medium flow rate; blue: low flow rate).

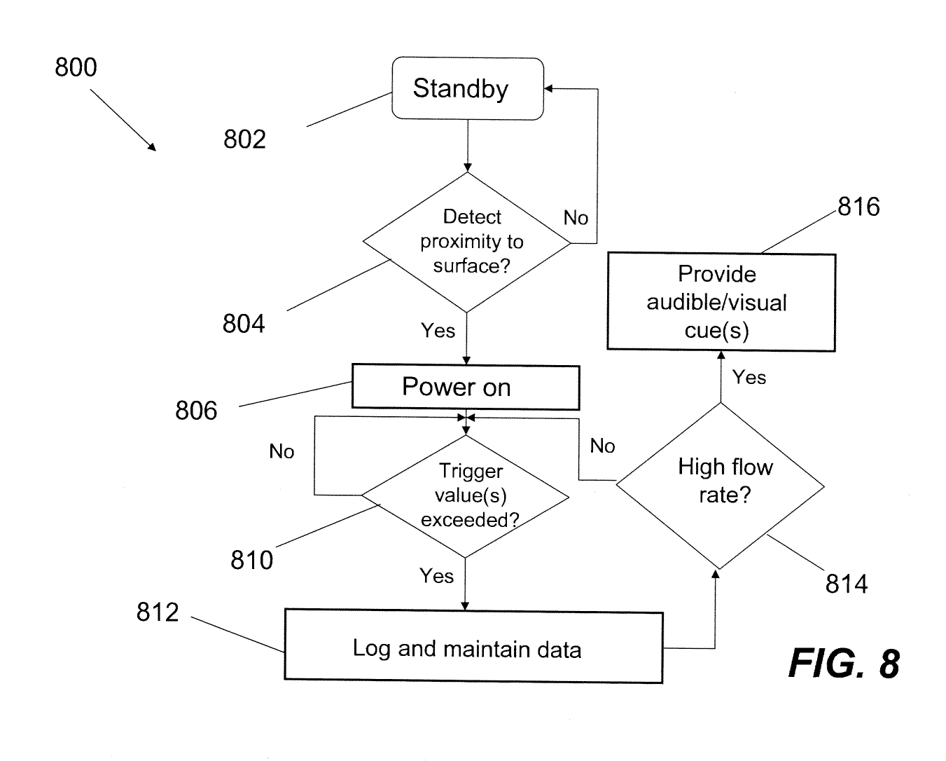

FIG. 8 is a flowchart illustrating a method 800 for conformal sensing of technical parameters, according to one embodiment of the present invention. The method of FIG. 8 illustrates some of the salient respective functions performed by the apparatus 100 described above in various embodiments, when the apparatus is used in connection with a piece of equipment. It should be appreciated, however, that while the method outlined in FIG. 8 is directed to sensing a flow rate in connection with a pipe and providing information relating to possible too-high a flow rate based on same, the concepts disclosed herein regarding conformal sensing may be applied more generally to a variety of arbitrarily-shaped surfaces. Accordingly, methods similar to the one outlined in FIG. 8 may be applied, at least in part, for conformal sensing of parameters proximate to surfaces of objects other than a pipe.

In block 802 of the method 800 shown in FIG. 8A, the apparatus 100 is indicated in “standby” mode; i.e., the switching circuitry 114 has not detected proximity to a surface of interest, and hence power from the power source 112 is not yet applied to various components of the apparatus relating to sensing. In block 804, if proximity to a surface of interest is detected by the switching circuitry 114 (e.g., if a capacitive probe of the switching circuitry detects a change in electric field arising from proximity to metal at a surface of a pipe, or content therein), the switching circuitry 114 functions to couple power from the power source 112 to various components of the apparatus 100, as indicated in block 806 (“Power on”).

In block 810 of FIG. 8, one or both of a force (e.g., a pressure) and a change in motion (e.g., an acceleration) are sensed by the apparatus 100, and the sensed force and/or change in motion is compared to one or more trigger values for these parameters. As noted above, various trigger values may be selected to correspond to different types of anticipated events from which possible equipment failure may result (e.g., trigger values associated with an overly-high flow rate, etc.). If the sensed parameter exceeds one or more trigger values, as indicated in block 812 the apparatus 100 begins to log and maintain data relating to the sensed parameter.

In particular, as discussed above in connection with FIGS. 6, 7A and 7B, the processor 110 of the apparatus 100 may be configured to sample and digitize the output signals 106 generated by one or more sensing elements, and log the digitized sampled output signals in the memory 108. In one aspect, the processor may convert digitized sampled output signals to appropriate units representing parameters (e.g., temperature, flow rate) so as to compare these parameters to corresponding trigger values. In another aspect, the processor may be configured to log and maintain data in the memory for a predetermined period of time following one or more trigger values being exceeded (e.g., the processor may record data for 5 seconds following an event represented by the trigger value(s)). Otherwise, if one or more trigger values are not exceeded in block 810, the processor 110 may merely continue to monitor (e.g., sample and digitize) output signals representing sensed force and/or change in motion and store data accordingly in a prescribed portion of the memory 108, but continuously write-over stored data in the prescribed portion of memory until one or more trigger values are exceeded (so as to conserve memory resources).

In block 814 of FIG. 8, the processor 110 of the apparatus 100, and/or an external processing device coupled to the apparatus 100 (e.g., via the communication interface 116), may analyze the data logged pursuant to block 812 to provide information relating to possible failure of a piece of equipment based on the sensed parameters. In one implementation, the mere fact that a sensed parameter is identified by the processor as exceeding one or more trigger values itself establishes some degree of possible failure (e.g., a “possible pipe failure” may be identified as corresponding to one or more particular trigger values being exceeded).

If possible equipment failure is assessed in block 814 of FIG. 8, one or more audible and/or visual cues may be provided representing the possible failure, as indicated in block 816.

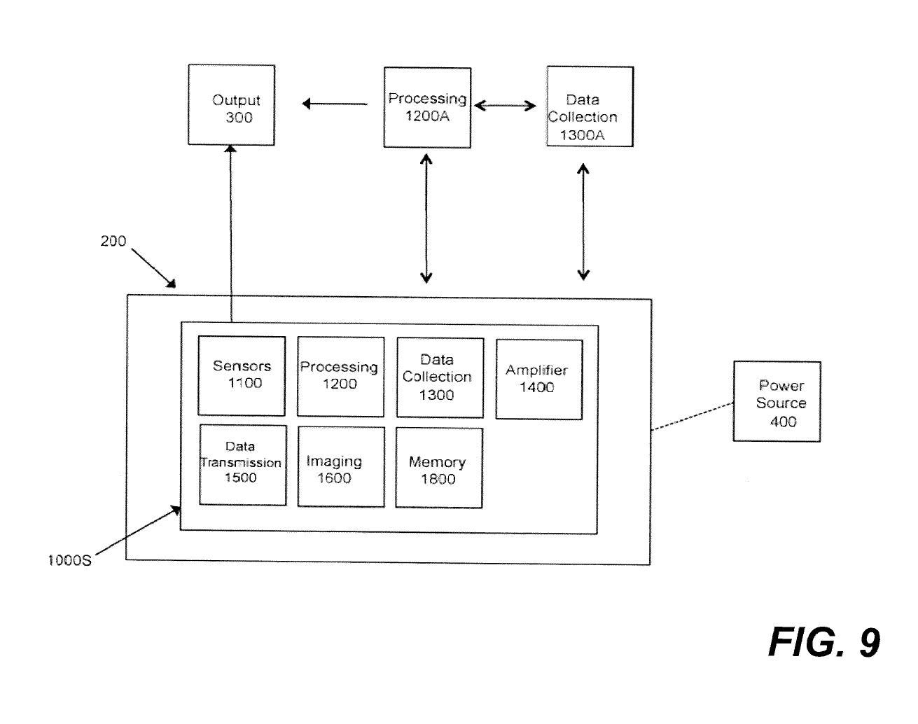

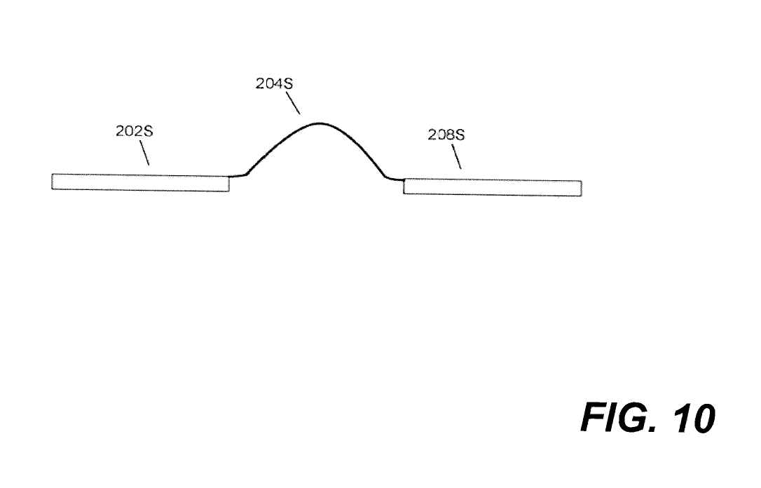

FIG. 9 is a schematic depiction of various embodiments of the invention. Further description of each of the components of FIG. 9 will be included throughout the specification. Circuitry 1000S is applied, secured, or otherwise affixed to substrate 200. In embodiments, substrate 200 is stretchable and/or expandable as described herein. As such, the substrate 200 can be made of a plastic material or can be made of an elastomeric material, or combinations thereof. Note that the term “plastic” may refer to any synthetic or naturally occurring material or combination of materials that can be molded or shaped, generally when heated, and hardened into a desired shape. The term “elastomer” may refer to a naturally occurring material or a synthetic material, and also to a polymeric material which can be stretched or deformed and return to its original shape without substantial permanent deformation. Such elastomers may withstand substantial elastic deformations. Examples of elastomers used in substrate material include polymeric organosilicon compounds (commonly referred to as “silicones”), including Polydimethylsiloxane (PDMS).

Other materials suitable for the substrate include polyimide; photopatternable silicone; SU8 polymer; PDS polydustrene; parylene and its derivatives and copolymers (parylene-N); ultrahigh molecular weight polyethylene; poly ether ether ketones (PEEK); polyurethanes (PTG Elasthane®, Dow Pellethane®); polylactic acid; polyglycolic acid; polymer composites (PTG Purisil A1®, PTG Bionate®, PTG Carbosil®); silicones/siloxanes (RTV 615®, Sylgard 184®); polytetrafluoroethylene (PTFE, Teflon®); polyamic acid; polymethyl acrylate; stainless steel; titanium and its alloys; platinum and its alloys; and gold. In embodiments, the substrate is made of a stretchable or flexible biocompatible material having properties which may allow for certain devices to be left in a living organism for a period of time without having to be retrieved. It should be noted that in embodiments the invention may apply to other living organisms, particularly mammals and should not be understood to be limited to humans.

Some of the materials mentioned above, specifically parylene and its derivatives and copolymers (parylene-N); ultrahigh molecular weight polyethylene; poly ether ether ketones (PEEK); polyurethanes (PTG Elasthane®, Dow Pellethane®); polylactic acid; polyglycolic acid; polymer composites (PTG Purisil A1®, PTG Bionate®, PTG Carbosil); silicones/siloxanes (RTV 615®, Sylgard 184®); polytetrafluoroethylene (PTFE, Teflon®); polyamic acid; polymethyl acrylate; stainless steel; titanium and its alloys; platinum and its alloys; and gold, are biocompatible. Coatings for the substrate to increase its biocompatibility may include, PTFE, polylactic acid, polyglycolic acid, and poly(lactic-co-glycolic acid).

The materials disclosed for substrate 200 herein may be understood to apply to any of the embodiments disclosed herein that require substrate. It should also be noted that materials can be chosen based on their properties which include degree of stiffness, degree of flexibility, degree of elasticity, or such properties related to the material's elastic moduli including Young's modulus, tensile modulus, bulk modulus, shear modulus, etc., and or their biodegradability.

The substrate 200 can be one of any possible number of shapes or configurations. In embodiments, the substrate 200 is substantially flat and in some embodiments configured to be a sheet or strip. Yet it should be noted that such flat configurations of substrate 200 could be any number of geometric shapes. Other embodiments of flat substrates will be described below including substrates having a tape-like or sheet configuration. Flexible and/or stretchable substrate 200 having a sheet or otherwise substantially flat configuration may be configured such that substrate 200 can be folded, furled, bunched, wrapped or otherwise contained. In embodiments, a substrate 200 configured as such can be folded, furled, bunched, collapsed (such as in an umbrella-like configuration), wrapped, or otherwise contained during delivery through narrow passageways and then deployed into an unfolded, unfurled, un-collapsed, etc. state once in position for deployment. As a non-limiting example, a furled substrate 200 carrying circuitry 100S comprising sensing device 1100 could be delivered via a catheter, then unfurled at such point when it is desired for the sensing device to contact the tissue of interest, such as the surface of the heart (inner or outer), or the inner surface of a lumen such as the pulmonary vein. In embodiments, substrates 200 may also be formed into concave and convex shapes, such as lenses. Such convex and concave substrates can be made of material suitable for contact with the eye, such as a contact lens, or for implantation into the eye, such a retinal or corneal implant.

Substrate 200 may also be three-dimensional. The three-dimensional substrate 200 can be any number of shapes. Such three-dimensional substrates may be a solid or substantially solid. In embodiments, the three-dimensional substrate may be pliable, flexible and stretchable while still comprising homogeneous or substantially homogenous material throughout its form, such as a foam or a flexible/stretchable polymeric sphere, ovoid, cylinder, disc, or other three-dimensional object. In embodiments, the three-dimensional substrate 200 may be made from several materials. In the presently preferred embodiment for the three-dimensional substrate 200, the substrate is an inflatable body (also referred to herein as an elastomeric vessel). Inflatable bodies of this type may be stretchable, such as a balloon or the like; however, in other embodiments, the inflatable body inflates without stretching. In embodiments, inflation can be achieved via a gas or liquid. In certain embodiments, inflation with a viscous fluid is preferable, but it should be clear that a variety of gases, fluids or gels may be employed for such inflation.

In embodiments where the substrate 200 is stretchable, circuitry 1000S is configured in the applicable manners described herein to be stretchable and/or to accommodate such stretching of the substrate 200. Similarly, in embodiments where the substrate 200 is flexible, but not necessarily stretchable, circuitry 1000S is configured in the applicable manners described herein to be flexible and/or accommodate such flexing of the substrate 200. Circuitry 1000S can be applied and/or configured using applicable techniques described below, including those described in connection with exemplary embodiments.

As mentioned above, the present invention may employ one or more of a plurality of flexible and/or stretchable electronics technologies in the implementation thereof. Traditionally, electronics have been fabricated on rigid structures, such as on integrated circuits, hybrid integrated circuits, flexible printed circuit boards, and on printed circuit boards. Integrated circuits, also referred to as ICs, microcircuits, microchips, silicon chips, or simple chips, have been traditionally fabricated on a thin substrate of semiconductor material, and have been constrained to rigid substrates mainly due to the high temperatures required in the step of inorganic semiconductor deposition. Hybrid integrated circuits and printed circuit boards have been the main method for integrating multiple ICs together, such as through mounting the ICs onto a ceramic, epoxy resin, or other rigid non-conducting surface. These interconnecting surfaces have traditionally been rigid in order to ensure that the electrical interconnection methods, such as solder joints to the board and metal traces across the boards, do not break or fracture when flexed. In addition, the ICs themselves may fracture if flexed. Thus, the field of electronics has been largely constrained to rigid electronics structures, which then tend to constrain electronics applications that may require flexibility and or stretchability necessary for the embodiments disclosed herein.

Advancements in flexible and bendable electronics technologies have emerged that enable flexible electronics applications, such as with organic and inorganic semiconductors on flexible plastic substrates, and other technologies described herein. Further, stretchable electronics technologies have emerged that enable applications that require the electronics to be stretchable, such as through the use of mounting ICs on flexible substrates and interconnected through some method of stretchable electrical interconnect, and other technologies as described herein. The present invention may utilize one or more of these flexible, bendable, stretchable, and like technologies, in applications that require the electronics to operate in configurations that may not be, or remain, rigid and planar, such as applications that require electronics to flex, bend, expand, stretch and the like.

In embodiments, the circuitry of the invention may be made in part or in full by utilizing the techniques and processes described below. Note that the below description of the various ways to achieve stretchable and/or flexible electronics is not meant to be limiting, and encompasses suitable variants and or modifications within the ambit of one skilled in the art. As such, this application will refer to the following U.S. patents and patent applications, each of which is incorporated by reference herein in its entirety: U.S. Pat. No. 7,557,367 entitled “Stretchable Semiconductor Elements and Stretchable Electrical Circuits”, issued Jul. 7, 2009 (the '367 patent“); U.S. Pat. No. 7,521,292 entitled “Stretchable Form of Single Crystal Silicon for High Performance Electronics on Rubber Substrates”, issued Apr. 29, 2009 (the '292 patent“); U.S. Published Patent Application No. 20080157235 entitled “Controlled Buckling Structures in Semiconductor Interconnects and Nano membranes for Stretchable Electronics”, filed Sep. 6, 2007 (the “'235 application”); U.S. patent application Ser. No. 12/398,811 entitled “Stretchable and Foldable Electronics”, filed Mar. 5, 2009 (the “'811 application”); U.S. Published Patent Application No. 20040192082 entitled “Stretchable and Elastic Interconnects” filed Mar. 28, 2003(the “'082 application”); United States Published Patent Application No. 20070134849 entitled “Method For Embedding Dies”, filed Nov. 21, 2006 (the “'849 application”); U.S. Published Patent Application No. 20080064125 entitled “Extendable Connector and Network, filed Sep. 12, 2007 (the “'125 application”); U.S. Provisional Patent Application having Ser. No. 61/240,262 (the “'262 application”) “Stretchable Electronics”, filed Sep. 7, 2009; U.S. patent application Ser. No. 12/616,922 entitled “Extremely Stretchable Electronics”, filed Nov. 12, 2009 (the “'922 application”); U.S. Provisional patent application Ser. No. 61/120,904 entitled “Transfer Printing”, filed Dec. 9, 2008 (the “'904 application”); U.S. Published Patent Application No. 20060286488 entitled “Methods and Devices for Fabricating Three-Dimensional Nanoscale Structures”, filed Dec. 1, 2004; U.S. Pat. No. 7,195,733 entitled “Composite Patterning Devices for Soft Lithography” issued Mar. 27, 2007; U.S. Published Patent Application No. 20090199960 entitled “Pattern Transfer Printing by Kinetic Control of Adhesion to an Elastomeric Stamp” filed Jun. 9, 2006; U.S. Published Patent Application. No. 20070032089 entitled “Printable Semiconductor Structures and Related Methods of Making and Assembling” filed Jun. 1, 2006; U.S. Published Patent Application No. 20080108171 entitled “Release Strategies for Making Transferable Semiconductor Structures, Devices and Device Components” filed Sep. 20, 2007; and U.S. Published Patent Application No. 20080055581 entitled “Devices and Methods for Pattern Generation by Ink Lithography”, filed Feb. 16, 2007.

“Electronic device” a/k/a “device” is used broadly herein to encompass an integrated circuit(s) having a wide range of functionality. In embodiments, the electronic devices may be devices laid out in a device island arrangement, as described herein including in connection to exemplary embodiments. The devices can be, or their functionality can include, integrated circuits, processors, controllers, microprocessors, diodes, capacitors, power storage elements, antennae, ASICs, sensors, image elements (e.g. CMOS, CCD imaging elements), amplifiers, A/D and D/A converters, associated differential amplifiers, buffers, microprocessors, optical collectors, transducer including electro-mechanical transducers, piezo-electric actuators, light emitting electronics which include LEDs, logic, memory, clock, and transistors including active matrix switching transistors, and combinations thereof. The purpose and advantage of using standard ICs (in embodiments, CMOS, on single crystal silicon) is to have and use high quality, high performance, and high functioning circuit components that are also already commonly mass-produced with well known processes, and which provide a range of functionality and generation of data far superior to that produced by a passive means. Components within electronic devices or devices are described herein, and include those components described above. A component can be one or more of any of the electronic devices described above and/or may include a photodiode, LED, TUFT, electrode, semiconductor, other light-collecting/detecting components, transistor, contact pad capable of contacting a device component, thin-film devices, circuit elements, control elements, microprocessors, interconnects, contact pads, capacitors, resistors, inductors, memory element, power storage element, antenna, logic element, buffer and/or other passive or active components. A device component may be connected to one or more contact pads as known in the art, such as metal evaporation, wire bonding, application of solids or conductive pastes, and the like.

Components incapable of controlling current by means of another electrical signal are called passive devices. Resistors, capacitors, inductors, transformers, and diodes are all considered passive devices

For purposes of the invention, an active device is any type of circuit component with the ability to electrically control electron flow. Active devices include, but are not limited to, vacuum tubes, transistors, amplifiers, logic gates, integrated circuits, semiconducting sensors and image elements, silicon-controlled rectifiers (SCRs), and triode for alternating current (TRIACs).

“Ultrathin” refers to devices of thin geometries that exhibit flexibility.

“Functional layer” refers to a device layer that imparts some functionality to the device. For example, the functional layer may be a thin film, such as a semiconductor layer. Alternatively, the functional layer may comprise multiple layers, such as multiple semiconductor layers separated by support layers. The functional layer may comprise a plurality of patterned elements, such as interconnects running between device-receiving pads.

Semiconductor materials which may be used to make circuits may include amorphous silicon, polycrystalline silicon, single crystal silicon, conductive oxides, carbon annotates and organic materials.

In some embodiments of the invention, semiconductors are printed onto flexible plastic substrates, creating bendable macro-electronic, micro-electronic, and/or nano-electronic devices. Such bendable thin film electronics devices on plastic may exhibit field effect performance similar to or exceeding that of thin film electronics devices fabricated by conventional high temperature processing methods. In addition, these flexible semiconductor on plastic structures may provide bendable electronic devices compatible with efficient high throughput processing on large areas of flexible substrates at lower temperatures, such as room temperature processing on plastic substrates. This technology may provide dry transfer contact printing techniques that are capable of assembling bendable thin film electronics devices by depositing a range of high quality semiconductors, including single crystal Si ribbons, GaAs, INP wires, and carbon nano-tubes onto plastic substrates. This high performance printed circuitry on flexible substrates enables an electronics structure that has wide ranging applications. The '367 patent and associated disclosure illustrates an example set of steps for fabricating a bendable thin film electronics device in this manner. (See FIG. 26A of the '367 patent for Example).

In addition to being able to fabricate semiconductor structures on plastic, metal-semiconductor electronics devices may be formed with printable wire arrays, such as GaAs micro-wires, on the plastic substrate. Similarly, other high quality semiconductor materials have been shown to transfer onto plastic substrates, including Si nano-wires, micro-ribbons, platelets, and the like. In addition, transfer-printing techniques using elastomeric stamps may be employed. The '367 patent provides an example illustration of the major steps for fabricating, on flexible plastic substrates, electronics devices that use arrays of single wires (in this instance GaAs wires) with epitaxial channel layers, and integrated holmic contacts. (See FIG. 41 of the '367 patent). In an example, a semi-insulating GaAs wafer may provide the source material for generating the micro-wires. Each wire may have multiple ohmic stripes separated by a gap that defines the channel length of the resultant electronic device. Contacting a flat, elastomeric stamp of PDMS to the wires forms a van der Waals bond. This interaction enables removal of all the wires from the wafer to the surface of the PDMS when the stamp is peeled back. The PDMS stamp with the wires is then placed against an uncured plastic sheet. After curing, peeling off the PDMS stamp leaves the wires with exposed ohmic stripes embedded on the surface of the plastic substrate. Further processing on the plastic substrate may define electrodes that connect the ohmic stripes to form the source, drain, and gate electrodes of the electronics devices. The resultant arrays are mechanically flexible due to the bendability of the plastic substrate and the wires.

In embodiments, and in general, stretchable electronics may incorporate electrodes, such as connected to a multiplexing chip and data acquisition system. In an example, an electrode may be fabricated, designed, transferred, and optionally encapsulated. In an embodiment, the fabrication may utilize and/or include an SI wafer; spin coating an adhesion layer (e.g. an HMDS adhesion layer); spin coating (e.g. PMMA) patterned by shadow mask, such as in oxygen RIE; spin coating Polyimide; depositing PECVD SiO2; spin 1813 Resist, photolithography patterning; metal evaporation (e.g. Ti, Pt, Au, and the like, or combination of the aforementioned); gold etchant, liftoff in hot acetone; spin Polyimide; PECVD SiO2; spin 1813 Resist, photolithography patterning; RIE etch, and the like. In this embodiment, the fabrication step may be complete with the electrodes on the Si wafer. In embodiments, the Si wafer may then be bathed in a hot acetone bath, such as at 100 C for approximately one hour to release the adhesion layer while PI posts keep electrode adhered to the surface of the Si wafer. In embodiments, electrodes may be designed in a plurality of shapes and distributed in a plurality of distribution patterns. Electrodes may be interconnected to electronics, multiplexing electronics, interface electronics, a communications facility, interface connections, and the like including any of the facilities/elements described on connection with FIG. 1 and/or the exemplary embodiments herein. In embodiments, the electrodes may be transferred from the Si wafer to a transfer stamp, such as a PDMS stamp, where the material of the transfer stamp may be fully cured, partially cured, and the like. For example, a partially cured PDMS sheet may be ˜350 nm, where the PDMS was spun on at 300 rpm for 60s, cured 65 C for 25 min, and used to lift electrodes off of the PDMS sheet. In addition, the electrodes may be encapsulated, such as wherein the electrodes are sandwiched between a supporting PDMS layer and second PDMS layer while at least one of the PDMS layers is partially cured.

In embodiments, stretchable electronics configurations may incorporate flex PCB design elements, such as flex print, chip-flip configurations (such as bonded onto the PCB), and the like, for connections to electrodes and/or devices, and for connections to interface electronics, such as to a data acquisition system (DAQ). For example, a flex PCB may be joined to electrodes by an anisotropic conductive film (ACF) connection, solder joints may connect flex PCB to the data acquisition system via conductive wires, and the like. In embodiments, the electrodes may be connected onto a surface by employing a partially cured elastomer (e.g. PDMS) as an adhesive.

In embodiments, stretchable electronics may be formed into sheets of stretchable electronics. In embodiments, stretchable sheets may be thin, such as approximately 100 μm. Optionally, amplification and multiplexing may be implemented without substantially heating the contact area, such as with micro-fluidic cooling.

In embodiments, a sheet having arrays of electronic devices comprising electrodes may be cut into different shapes and remain functional, such as through communicating electrode islands which determine the shape of the electrode sheet. Electrodes are laid out in a device island arrangement (as described herein) and may contain active circuitry designed to communicate with each other via inter-island stretchable interconnects so that processing facility (described herein) in the circuitry can determine in real-time the identity and location of other such islands. In this way, if one island becomes defective, the islands can still send out coordinated, multiplexed data from the remaining array. Such functionality allows for such arrays to be cut and shaped based on the size constraints of the application. A sheet, and thus circuitry, may be cut to size and the circuitry will poll remaining electrodes and/or devices to determine which are left and will modify the calibration accordingly. An example of a stretchable electronics sheet containing this functionality, may include electrode geometry, such as a 20×20 array of platinum electrodes on 1 mm pitch for a total area of 20×20 mm²; an electrode impedance, such as 5 kohm at 1 khz (adjustable); a configuration in a flexible sheet, such as with a 50 μm total thickness, and polyimide encapsulated; a sampling rate, such as 2 kHz per channel; a voltage dynamic range, such as +/−6 mV; a dc voltage offset range, such as −2.5 to 5 V, with dc rejection; a voltage noise, such as 0.002 mV, a maximum signal-to-noise ratio, such as 3000; a leakage current, such as 0.3 μA typical, 10 μA maximum, as meets IEC standards, and the like; an operating voltage of 5 V; an operating power per channel, such as less than 2 mW (adjustable); a number of interface wires, such as for power, ground, low impedance ground, data lines, and the like; a voltage gain, such as 150; a mechanical bend radius, such as 1 mm; a local heating capability, such as heating local tissue by up to 1° C.; biocompatibility duration, such as 2 weeks; active electronics, such as a differential amplifier, a multiplexer (e.g. 1000 transistors per channel); a data acquisition system, such as with a 16 bit A/D converter with a 500 kHz sampling rate, less than 2 μV noise, data login and real-time screen display; safety compliance, such as to IEC10601; and the like. While the above example is applicable to the therapeutic and medical context, it should be appreciated that such cut-to-size sheets may be used in other scenarios not necessarily requiring biocompatibility or physiological sensors.

In embodiments of the invention, mechanical flexibility may represent an important characteristic of devices, such as on plastic substrates, for many applications. Micro/nano-wires with integrated ohmic contacts provide a unique type of material for high performance devices that can be built directly on a wide range of device substrates. Alternatively, other materials may be used to connect electrical components together, such as connecting electrically and/or mechanically by thin polymer bridges with or without metal interconnects lines.

In embodiments, an encapsulation layer may be utilized. An encapsulating layer may refer to coating of the device, or a portion of the device. In embodiments, the encapsulation layer may have a modulus that is inhomogeneous and/or that spatially varies. Encapsulation layers may provide mechanical protection, device isolation, and the like. These layers may have a significant benefit to stretchable electronics. For example, low modulus PDMS structures may increase the range of stretchability significantly (described at length in the '811 application). The encapsulation layer may also be used as a passivation later on top of devices for the protection or electrical isolation. In embodiments, the use of low modulus strain isolation layers may allow integration of high performance electronics. The devices may have an encapsulation layer to provide mechanical protection and protection against the environment. The use of encapsulation layers may have a significant impact at high strain. Encapsulants with low moduli may provide the greatest flexibility and therefore the greatest levels of stretchability. As referred to in the '811 application, low modulus formulations of PDMS may increase the range of stretchability at least from 60%. Encapsulation layers may also relieve strains and stresses on the electronic device, such as on a functional layer of the device that is vulnerable to strain induced failure. In embodiments, a layering of materials with different moduli may be used. In embodiments, these layers may be a polymer, an elastomer, and the like. In some embodiments directed to therapeutic or medical applications, an encapsulation may serve to create a biocompatible interface for an implanted stretchable electronic system, such as Silk encapsulation of electronic devices in contact with tissue.

Returning to flexible and stretchable electronics technologies that may be utilized in the present invention, it has been shown that buckled and wavy ribbons of semiconductor, such as GaAs or Silicon, may be fabricated as part of electronics on elastomeric substrates. Semiconductor ribbons, such as with thicknesses in the submicron range and well-defined, ‘wavy’ and/or ‘buckled’ geometries have been demonstrated. The resulting structures, on the surface of, or embedded in, the elastomeric substrate, have been shown to exhibit reversible stretchability and compressibility to strains greater than 10%. By integrating ohmic contacts on these structured GaAs ribbons, high-performance stretchable electronic devices may be achieved. The '292 patent illustrates steps for fabricating stretchable GaAs ribbons on an elastomeric substrate made of PDMS, where the ribbons are generated from a high-quality bulk wafer of GaAs with multiple epitaxial layers (See FIG. 22 in the '292 patent). The wafer with released GaAs ribbons is contacted to the surface of a pre-stretched PDMS, with the ribbons aligned along the direction of stretching. Peeling the PDMS from the mother wafer transfers all the ribbons to the surface of the PDMS. Relaxing the prestrain in the PDMS leads to the formation of large-scale buckles/wavy structures along the ribbons. The geometry of the ribbons may depend on the prestrain applied to the stamp, the interaction between the PDMS and ribbons, and the flexural rigidity of the ribbons, and the like. In embodiments, buckles and waves may be included in a single ribbon along its length, due for example, to thickness variations associated with device structures. In practical applications, it might be useful to encapsulate the ribbons and devices in a way that maintains their stretchability. The semiconductor ribbons on an elastomeric substrate may be used to fabricate high-performance electronic devices, buckled and wavy ribbons of semiconductor multilayer stacks and devices exhibiting significant compressibility/stretchability. In embodiments, the present invention may utilize a fabrication process for producing an array of devices utilizing semiconductor ribbons, such as an array of CMOS inverters with stretchable, wavy interconnects. Also, a strategy of top layer encapsulation may be used to isolate circuitry from strain, thereby avoiding cracking

In embodiments, a neutral mechanical plane (NMP) in a multilayer stack may define the position where the strains are zero. For instance, the different layers may include a support layer, a functional layer, a neutral mechanical surface adjusting layer, an encapsulation layer with a resultant neutral mechanical surface such as coincident with the functional layer, and the like. In embodiments, the functional layer may include flexible or elastic device regions and rigid island regions. In embodiments, an NMP may be realized in any application of the stretchable electronics as utilized in the present invention.

In embodiments, semiconductor ribbons (also, micro-ribbons, nano-ribbons, and the like) may be used to implement integrated circuitry, electrical interconnectivity between electrical/electronic components, and even for mechanical support as a part of an electrical/electronic system. As such, semiconductor ribbons may be utilized in a great variety of ways in the configuration/fabrication of flexible and stretchable electronics, such as being used for the electronics or interconnection portion of an assembly leading to a flexible and/or stretchable electronics, as an interconnected array of ribbons forming a flexible and/or stretchable electronics on a flexible substrate, and the like. For example, nano-ribbons may be used to form a flexible array of electronics on a plastic substrate. The array may represent an array of electrode-electronics cells, where the nano-ribbons are pre-fabricated, and then laid down and interconnected through metallization and encapsulation layers. Note that the final structure of this configuration may be similar to electronic device arrays as fabricated directly on the plastic, as described herein, but with the higher electronics integration density enabled with the semiconductor ribbons. In addition, this configuration may include encapsulation layers and fabrication steps which may isolate the structure from a wet environment. This example is not meant to limit the use of semiconductor ribbons in any way, as they may be used in a great variety of applications associated with flexibility and stretchability. For example, the cells of this array may be instead connected by wires, bent interconnections, be mounted on an elastomeric substrate, and the like, in order to improve the flexibility and/or stretchability of the circuitry.

Wavy semiconductor interconnects is only one form of a broader class of flexible and stretchable interconnects that may (in some cases) be referred to as ‘bent’ interconnects, where the material may be semiconductor, metal, or other conductive material, formed in ribbons, bands, wire, traces, and the like. A bent configuration may refer to a structure having a curved shape resulting from the application of a force, such as having one or more folded regions. These bent interconnections may be formed in a variety of ways, and in embodiments, where the interconnect material is placed on an elastomeric substrate that has been pre-strained, and the bend form created when the strain is released. In embodiments, the pre-strain may be pre-stretched or pre-compressed, provided in one, two, or three axes, provided homogeneously or heterogeneously, and the like. The wavy patterns may be formed along pre-strained wavy patterns, may form as ‘pop-up’ bridges, may be used with other electrical components mounted on the elastomer, or transfer printed to another structure. Alternately, instead of generating a ‘pop-up’ or buckled components via force or strain application to an elastomeric substrate, a stretchable and bendable interconnect may be made by application of a component material to a receiving surface. Bent configurations may be constructed from micro-wires, such as transferred onto a substrate, or by fabricating wavy interconnect patterns either in conjunction with electronics components, such as on an elastomeric substrate.

Semiconductor nanoribbons, as described herein, may utilize the method of forming wavy ‘bent’ interconnections through the use of forming the bent interconnection on a pre-strained elastomeric substrate, and this technique may be applied to a plurality of different materials. Another general class of wavy interconnects may utilize controlled buckling of the interconnection material. In this case, a bonding material may be applied in a selected pattern so that there are bonded regions that will remain in physical contact with the substrate (after deformation) and other regions that will not. The pre-strained substrate is removed from the wafer substrate, and upon relaxation of the substrate, the unbounded interconnects buckle (‘pop-up’) in the unbonded (or weakly bonded) regions. Accordingly, buckled interconnects impart stretchability to the structure without breaking electrical contact between components, thereby providing flexibility and/or stretchability.

FIG. 9 shows a simplified diagram showing a buckled interconnection 204S between two components 2025 and 208S. The flexible and/or stretchable interconnect can be disposed on the flexible and/or stretchable substrate to couple the at least one sensing element to at least the processor, and includes at least one of a wavy interconnect, a bent interconnect, a buckled interconnect, an encapsulated interconnect, and a serpentine pattern of conductive metal, as described above.

In embodiments, any, all, or combinations of each of the interconnection schemes described herein may be applied to make an electronics support structure more flexible or bendable, such as applying bent interconnects to a flexible substrate, such as plastic or elastomeric substrates. However, these bent interconnect structures may provide for a substantially more expandable or stretchable configuration in another general class of stretchable electronic structures, where rigid semiconductor islands are mounted on an elastomeric substrate and interconnected with one of the plurality of bent interconnect technologies. This technology is presented here, and also in the '262 application, which has been incorporated by reference in its entirety. This configuration also uses the neutral mechanical plane designs, as described herein, to reduce the strain on rigid components encapsulated within the system. These component devices may be thinned to the thickness corresponding to the desired application or they may be incorporated exactly as they are obtained. Devices may then be interconnected electronically and encapsulated to protect them from the environment and enhance flexibility and stretchability.

In an embodiment, the first step in a process to create stretchable and flexible electronics as described herein involves obtaining required electronic devices and components and conductive materials for the functional layer. The electronics are then thinned (if necessary) by using a back grinding process. Many processes are available that can reliably take wafers down to 50 microns. Dicing chips via plasma etching before the grinding process allows further reduction in thickness and can deliver chips down to 20 microns in thickness. For thinning, typically a specialized tape is placed over the processed part of the chip. The bottom of the chip is then thinned using both mechanical and/or chemical means. After thinning, the chips may be transferred to a receiving substrate, wherein the receiving substrate may be a flat surface on which stretchable interconnects can be fabricated.

Stretchable circuits 1000S may be utilized to improve many products and processes, such as found in commercial, consumer, industrial, and like markets. Stretchable circuits 1000S may be utilized to provide improved or added functions to products and processes due to the ability of stretchable circuits 1000S to stretch and conform to changing surface characteristics. In this way, stretchable circuits 1000S may be applied to surfaces that may change in time due to stretching, vibration, and the like. Stretchable circuits 1000S may be able to collect data on such surfaces, such as transmitted from the stretchable circuits 1000S or stored on the stretchable circuits 1000S for subsequent retrieval. For instance, stretchable circuits 1000S may be applied to monitoring the surface, such as through sensors; imaging the surface or imaging from the surface through application of stretchable imaging arrays; collecting data as associated with conditions and/or characteristics of a changing surface; providing electronics to harsh environments, where conventional electronics could fail due to the environment, such as in a vibrating environment; adapting to the shape of a surface, especially where that surface may change in time, such as through vibrations, expansion, and motion; and the like. Stretchable circuits 1000S may be placed in products that need to tolerate difficult environments, motion/shock, and the like; for instance, products that can be shaped into different media form factors before and/or after manufacture and that can benefit from a high density of sensor/actuator nodes on a curved surface (e.g. a tactile sensor array).

In embodiments, stretchable circuits 1000S may be utilized to monitor a surface. For example, permanent or temporary application of a stretchable circuits 1000S sheet to the surface of an expandable surface or joint may be used to monitor displacement, temperature, vibrations, tilt, and the like. This may provide an advantage offered by stretchability, such as tolerance for surface changes or motion during monitoring, and ease of application.

In embodiments, stretchable circuits 1000S may be utilized to provide a surface, such as to a product, which includes a stretchable image array. This may provide an advantage offered by stretchability, such as providing an imaging surface that may stretch and contour to the application surface, such as during application, providing stretchable tolerance for dynamic systems, and the like. A stretchable image array may be an integral part of the product, or may be added as in a post-market application. The stretchable image array may be designed to provide monitoring of the surrounding environment, such as in surveillance, test monitoring, product monitoring, and the like. In embodiments, a stretchable circuits 1000S array may provide imaging from a surface associated with a harsh environment, such as described herein. In embodiments, conformal surface sensors on the stretchable image array may receive a variety of signals from emitter sources (e.g., all electromagnetic radiation sources). In embodiments, stretchability may allow the production of very small cameras with performance exceeding that of similarly sized cameras. Sensor elements may also be laid out on the surface of an object in order to get a map (image) of parameters in the environment such as heat, pressure, and the like.

In embodiments, stretchable circuits 1000S may be utilized for products used in unusually shaped environments and/or form factors. For instance, an electronics application may provide the ability to create products that are shaped, or can be shaped to a surface, be tolerant to unusual form factors, e.g., modules bent or squeezed into unusual shapes, shaped during manufacture to fit onto 3D surfaces which either remain static during the life of the object, or change in shape and size with time, and the like.

In embodiments, stretchable circuits 1000S may be utilized to collect and/or store data, such as with stretchable circuits 1000S on the surface of a device, container, test fixture, and the like. In embodiments, the stretchable data collection facility may be integrated, or may be applied. This application may provide the advantage offered by stretchability, such as a stretchable data collection sheet contouring to a surface and tolerant to changes in surface during vibration, expansion, motion, and the like; for example, applying a stretchable circuits 1000S sheet to various surfaces of a device undergoing testing or transit (thermal, shock, vibration, acceleration, etc.) to collect and store data.

In embodiments, stretchable circuits 1000S may be utilized to provide an environment tolerant electronics module, products used in motion, with harsh handling, and the like, such as for consumer, commercial, industrial, and the like applications. For example, providing conventional electronics capabilities in a stretchable form factor for electronics devices used in harsh commercial environments, such as tolerance for dynamic factors, such as vibration, acceleration, motion, thermal, and like effects and conditions. Due to the stretchability of the electronics package, it may be possible to maintain electrical performance of devices integrated into stretchable and bendable articles, regardless of deformation of said article.

In embodiments, stretchable circuits 1000S may be applied to a plurality of markets, such as consumer, commercial, industrial, lighting, military, and the like markets. Exhibits A, B, and C provide a non-limiting set of examples of applications within the commercial, commercial, and industrial markets respectively. In these exhibits, the terms circuitry 1000S, as applied, secured, or otherwise affixed to substrate 200, is used interchangeably with the term stretchable electronics component 1001A, 1001B, and 1001C. It will be apparent to one skilled in the art that an electronics component 1001A, 1001B, and 1001C, including circuitry 1000S on a stretchable substrate 200, may be used in the improvement of a great number of devices through embodiments of the present invention.

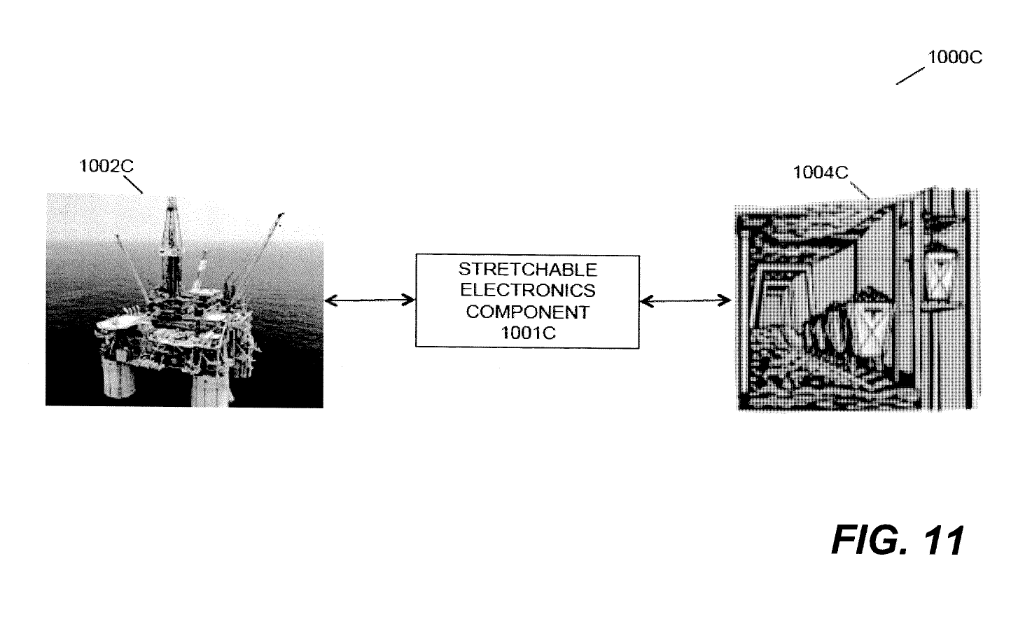

In embodiments, as illustrated in FIG. 11, a stretchable electronics component 1001C may be utilized to improve industrial products used in raw material extraction and create a stretchable component based product operated such as in drilling equipments 1002C, mining equipments 1004C and the like. For instance, the drilling equipment 1002C such as a drill bit, drill pipe, rotary table, lifting hook, mud pump, derrick, and the like may be designed with a stretchable electronics component 1001C such as a stretchable electronics board. The electronic components may be embedded in the stretchable Printed Circuit Board, which may be associated with the mechanical devices. The Stretchable PCB may offer flexibility/stretchability during aggregation of data. For example, the trajectory of the cutting blade of a CNC machine may be electronically controlled and the circuitry (PCB) associated with the cutting blade may be stretchable to avoid breakage or malfunction. Likewise, the stretchable electronics susceptible to operate under higher temperatures may bend/expand/ or stretch at higher temperature without affecting the operation of the equipment.

Combined with a stretchable and/or flexible structure, properties of the drilling equipment 1002C may be enhanced. For example, the stretchable electronics component 1001C may deform in shape without degradation to functional performance. Further, the stretchable electronics component 1001C such as the electronics board for the drilling equipment 1002C may be flexed and/or deformed without harm to the electrical integrity of the stretchable electronics board. Similarly, the mining equipments 1004C such as drills, lighting units, automated trolleys, slurry pumps, cement injectors, exhaust fans, clay diggers, and the like may be designed with the stretchable electronics component 1001C such as a stretchable electronics board. Combined with a stretchable and/or flexible structure, properties of the mining equipment 1004C may be enhanced.

In another scenario, a multilayer stretchable electronic board may be utilized to reduce the size of the electronic circuitry in drilling operations. In this regard, the size of the electronic circuitry may be reduced or increased by stretching without affecting the performance of the electronics. For example, a small module of minute components may be fabricated from materials that are stretchable thereby forming stretchable electronics. These stretchable electronics components may be embedded in various devices described herein and elsewhere to form circuitry that is flexible and stretchable. For example, if a device has a curvature then the stretchable electronics may be affixed to it by stretching the electronics (PCB and components) without affecting its performance.

In usual scenarios, raw material extraction such as extraction of metal ores, petroleum and the like include equipments that may experience extremely harsh and rough conditions such as high temperature, high pressure, high humidity levels or extreme dryness, rough handling and the like. Mechanical components therefore, need to be designed with greater strength to tolerate extreme conditions. Simultaneously, stretchable electronic components/stretchable printed circuit board or both that may be fitted in these mechanical components such as drilling equipments 1002C, mining equipments 1004C and the like may deform on experiencing extremely harsh and rough conditions thereby preventing the stretchable electronics component 1001C embedded such as within the drilling equipments 1002C, mining equipments 1002C and the like from damages and failures.

In embodiments, the stretchable electronics component 1001C as well as stretchable electronic boards such as stretchable PCB may be utilized for surface monitoring of drill assemblies or drill equipments 1002C such as those mentioned above without limitations. These miniature electronic boards may be embedded in various mechanical component and devices. For example, stretchable electronics circuitry may be employed as a sensing unit susceptible to high temperature. This may include temperature sensing, pressure sensing, humidity/dryness determination, chemical sensing and the like. In accordance with these embodiments, imaging devices, vision systems, sensors and the like may be deployed on the drilling equipments 1002C and the mining equipments 1004C. The imaging devices, vision systems, sensors and other such systems may be embedded with stretchable electronics component 1001C that may deform on an application of external harsh conditions thereby preventing malfunctioning of the drilling equipments 1002C and the mining equipments 1004C. Similarly, in accordance with another embodiment, surface monitoring systems such as imaging devices, vision systems, sensors and the like may be fitted on remote probes. The stretchable electronics component and stretchable printed circuit boards 1002C may be embedded with imaging systems; the imaging system may operate in hazardous areas and may be deformed into any shape because of the stretchable nature of the electronics affixed in it. Likewise, high density arrays may be placed inside the structural design or on the surface of the drilling equipments 1002C and the mining equipments 1004C to monitor crack propagation and fractures. The stretchable electronics component based imaging layers, systems and arrays may tolerate harsh nature of cracks, fractures, vibrations, shocks and the like.

In embodiments, several types of imaging and sensing layers, systems and arrays may be positioned inside deep boreholes such as during drilling operations that may sense information and capture images relevant to functional and operational parameters of the drilling equipments 1002C such as bore width, bore depth, cutting rate, and the like and nature of soil such as water content, porosity of the soil, oil content and the like, and transmit the information and images to a computer or server for further utilization and planning. In a similar manner, various control electronics modules having stretchable electronics component 1001C or stretchable electronics boards or any combination of these may be designed to control operational and functional parameters in an environment prone to stresses, vibrations, shocks, and other harsh physical conditions based on sensing and comparing sensed information with optimum levels.

The stretchable electronic component/stretchable electronic board may be employed in sensors and/or other test devices for recording technical parameters of the various devices. For example, test data sheets may be applied on drilling equipments 1002C and mining equipments 1004C to monitor and collect operational and functional parameters during testing and operation of the equipments. These data sheets may take the form of a delicate electronic layer, imaging layer, recording layer, discrete sensors and vision systems and the like. In one embodiment, the stretchable electronic component along with a transducer such as a load cell may be affixed in a device capable of recording load on a platform. The stretchable electronics component may be associated with the load cell, which may deform/stretch without affecting the performance of the device. In another embodiment, a test data sheet may be in the form of electronic stickers that may be attached to the drilling equipments 1002C and the mining equipments 1004C. Test data sheets may be damaged owing to external physical conditions and mishandling. Stretchable components embedded within test sheets allow surface monitoring, health monitoring, structural, operational and functional parameters monitoring of the equipments without being defunct due to the stretchable and/or flexible character that may create deformation to counter the effect of external physical conditions.

A test datasheet may be an electronic display device embedded with stretchable electronic components/stretchable electronic boards. Such an electronic display device may be stretched/compressed to fit in a space for taking measurements. In this aspect, the stretchable electronics component may be flexible and stretchable to be attached at various locations and facilities due to its shape.

Likewise, stretchable electronic interfaces such as ports may be stretched for affixing them with their corresponding mating parts. For example, an RS232 interface port may be fabricated using stretchable material and stretchable electronic components to form a port that may be altered by stretching to adjust to fit into their corresponding ports.

In embodiments, test data sheets may be reused on several types of equipments with varying sizes, dimensions, texture and the like. The stretchable electronics component 1001C may deform and conform data sheets to any shape on which the data sheets have been applied thereby allowing application of the same datasheet on multiple arbitrarily shaped surfaces.

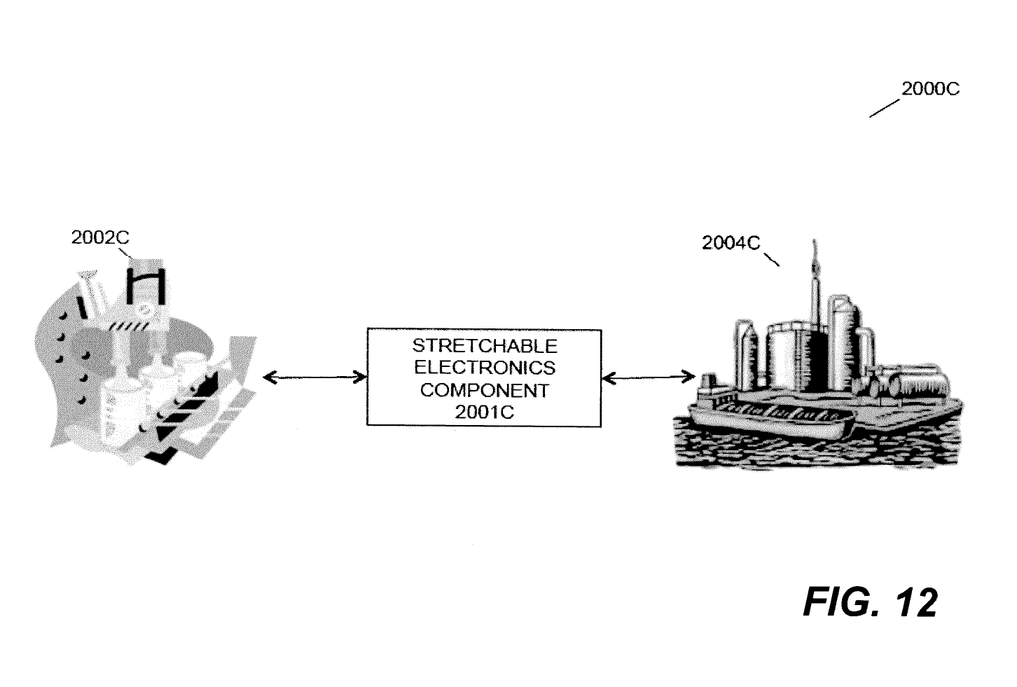

In embodiments, as illustrated in FIG. 12, a stretchable electronics component 2001C may be utilized to improve industrial products that may be utilized in a processing industry 2002C, refinery 2004C and the like to create a stretchable electronics enabled industrial product operated in processing and refining equipments. The processing equipment may include, without limitations, processing containers, ducts and pipes, chillers, heaters, cutters, filters, purifiers, recycling devices, and the like and products operated in refineries may include, without limitations, hydrogen synthesizers, steam generators, gas processor, vacuum distillation column, and the like. For instance, a vacuum distillation column may be designed with a stretchable electronics component 2001C such as a stretchable electronics board, a stretchable layer, nano-stretchable material film and the like. Combined with a stretchable and/or flexible structure, properties of the processing equipments 2002C and the refining equipments may be enhanced, where the stretchable electronics component 2001C may deform in shape without degradation to functional performance. For example, a stretchable electronics film placed on refinery equipments 2004C may be flexed and/or deformed without harm to the electrical/electronic integrity of the stretchable electronics film.

Most of the industrial products are embedded with electronic circuitry that usually needs protection since electronics is vulnerable to breaking. In order to overcome this deficiency, industrial products may be fabricated using stretchable electronic components that may stretch/deform or change shape without affecting the performance of the industrial product.

In embodiments, the stretchable electronics component 2001C may be utilized for surface monitoring of processing equipments 2002C and refinery equipments 2004C such as those mentioned above without limitations. This may include temperature sensing, pressure sensing, humidity/dryness determination, chemical sensing and the like. In accordance with these embodiments, imaging devices, vision systems, sensors and the like may be deployed on the processing equipments 2002C and refinery equipments 2004C. Imaging devices, vision systems, sensors and other such systems may be embedded with stretchable electronics component 2001C that may deform on an application of external harsh conditions causing malfunctioning of the processing equipments 2002C and refinery equipments 2004C. Similarly, in accordance with another embodiment, surface monitoring systems such as imaging devices, vision systems, sensors and the like may be fitted on remote probes that may enable remote communication from stretchable sensing and imaging systems to a distantly located server.

In embodiments, imaging devices, vision systems, sensors and the like may be disposed within the refinery for monitoring refining equipments 2004C for faults and cracking. In yet another embodiment, a thin layer with nano-stretchable electronics component may be provided at an inner surface of the refinery equipments 2004C that may allow filling of cracks or defects in a self-healing manner by required stretching of the nano-stretchable electronics component in several dimensions.

In embodiments, test data sheets generated by electronics test devices may be associated with monitoring and imaging devices fitted within the processing equipments 2002C and refinery equipments 2002C to monitor and collect operational and functional parameters during monitoring, testing and operation of the equipments. These electronics devices configured to generate test data may aggregate parameters/technical details of various equipments may be embedded with stretchable electronic component/stretchable electronic boards to allow them to fit in a small location. Likewise, a device made from flexible material may be stretched or deformed to fit in a small location. Further, these data sheets may be utilized for quality management, maintenance, wear control and prevention, and other similar purposes. Data sheets may take the form of a delicate electronic layer, imaging layer, recording layer, discrete sensors and vision systems and the like. Further, test data sheets may be in the form of electronic stickers that may be attached to the processing equipments 2002C and the refinery equipments 2004C. Test data sheets may be damaged owing to external physical conditions and mishandling. Stretchable components embedded within test sheets allow surface monitoring, health monitoring, operational and functional parameters monitoring of the equipments without being defunct due to the stretchable and/or flexible character that may create deformation to counter the effect of external physical conditions. Further, the stretchable electronics component 2001C may deform and conform data sheets to any shape on which the data sheets may be applied thereby allowing application of the same datasheet on multiple arbitrarily shaped surfaces.

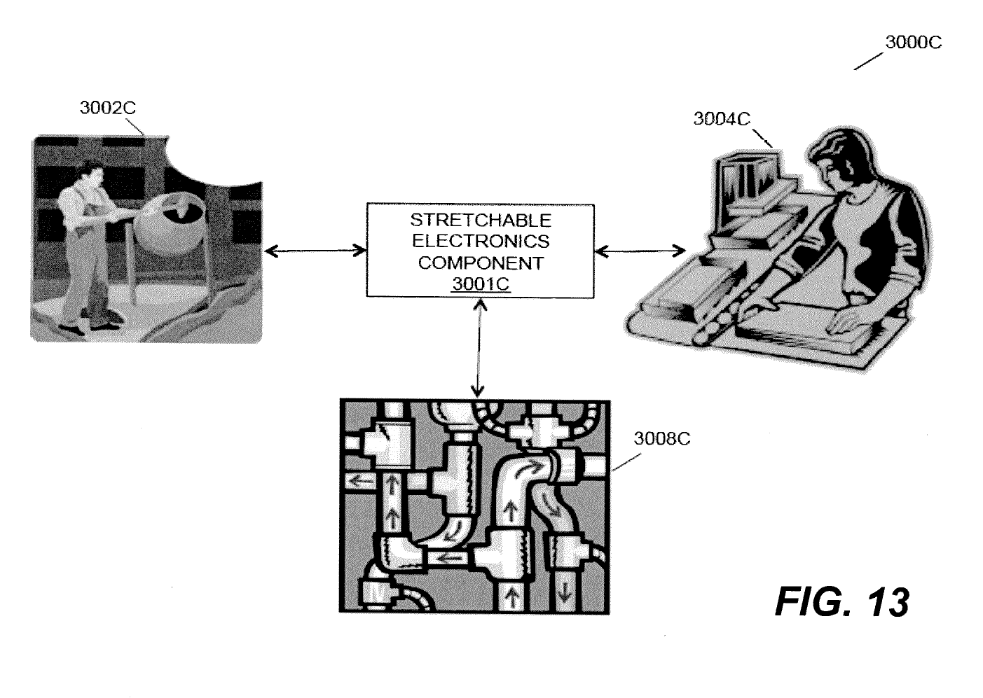

In embodiments, as illustrated in FIG. 13, a stretchable electronics component 3001C may be utilized to improve industrial products used in construction 3002C such as construction of railway lines, construction of bridges, construction of buildings and the like to create a stretchable electronics enabled construction product or construction site. For instance, construction equipments may be mounted with sensing devices embedded with stretchable electronics such as a stretchable electronics board, stretchable electronics layer, stretchable electronics film and the like. Combined with a stretchable and/or flexible structure, properties of the stretchable electronics enabled construction equipments or sites 3002C may be enhanced, where the stretchable electronics component 3001C may deform in shape without degradation to functional performance. For example, the stretchable electronics component 3001C that may be the electronics board (i.e. a stretchable electronics board) may be flexed and/or deformed without harm to the electrical integrity of the stretchable electronics board.

In embodiments, stretchable electronics component 3001C may be fitted within imaging, sensing and monitoring devices/layers/films that are mounted and disposed on construction equipments 3002C. Further, test data sheets may be associated with sensing, monitoring and imaging devices fitted within the construction equipments 3002C to monitor and collect operational and functional parameters during, monitoring, testing and operation of the construction equipments and/or sites. These data sheets may be utilized for construction, quality management, maintenance and other similar purposes. Data sheets may take the form of a delicate electronic layer, imaging layer, recording layer, discrete sensors and vision systems and the like. Further, test data sheets may be in the form of electronic stickers that may be attached to the construction equipments 3002C. Test data sheets may be damaged owing to external physical conditions and mishandling. Stretchable components embedded within test sheets may allow surface monitoring, health monitoring, operational and functional parameters monitoring of the equipments without being defunct due to the stretchable and/or flexible character that may create deformation to counter the effect of external physical conditions. Further, the stretchable electronics component 3001C may deform and conform data sheets to any shape on which the data sheets may be applied thereby allowing application of the same datasheet on multiple arbitrarily shaped surfaces.

In embodiments, the imaging, sensing, monitoring devices and layers having stretchable electronics component 3001C may be fitted or disposed on a surface such as a joint 3008C during assembly of multiple elements such as ducts and pipes or during construction. This may enable the stretchable electronics component 3001C to deform in shape during severe environmental conditions such as shocks, vibrations, physical conditions and the like thereby preventing fragile devices like sensors from damages. Further, nano-stretchable electronics component 3001C may be disposed in the form of a thin layer that may deform to fill cracks thereby preventing further crack propagation.

In accordance with various embodiments, stretchable electronics component 3001C may be embedded with an imaging surface provided inside an assembly during assembly integration 3004C. This may enable best fitting or fastening during integration of multiple assemblies. The stretchable electronics component 3001C may, in such a scenario, deform in shape to conform corresponding fastening elements and fasteners and allow secured fastening.

In embodiments, stretchable electronics component 3001C may be embedded within an imaging surface of sensors and other monitoring devices provided in pipelines 3008C. This may be utilized in applications such as pipeline inspection. Since flow conditions inside a pipeline may be extremely severe, therefore normal sensing and monitoring devices may get damaged. However, stretchable electronics component 3001C enables sensing and monitoring devices to tolerate severe conditions prevailing inside pipelines. Further, stretchable electronics component 3001C may be utilized for inspection and monitoring of welds in pipelines. In such a scenario, the monitoring or sensing sheet may stretch and expand out to surface. The inspection of pipelines may be conducted using automated vehicles such as robotic assemblies, where stretchable electronics may provide a fault proof mechanism and hence automating the whole inspection system completely.

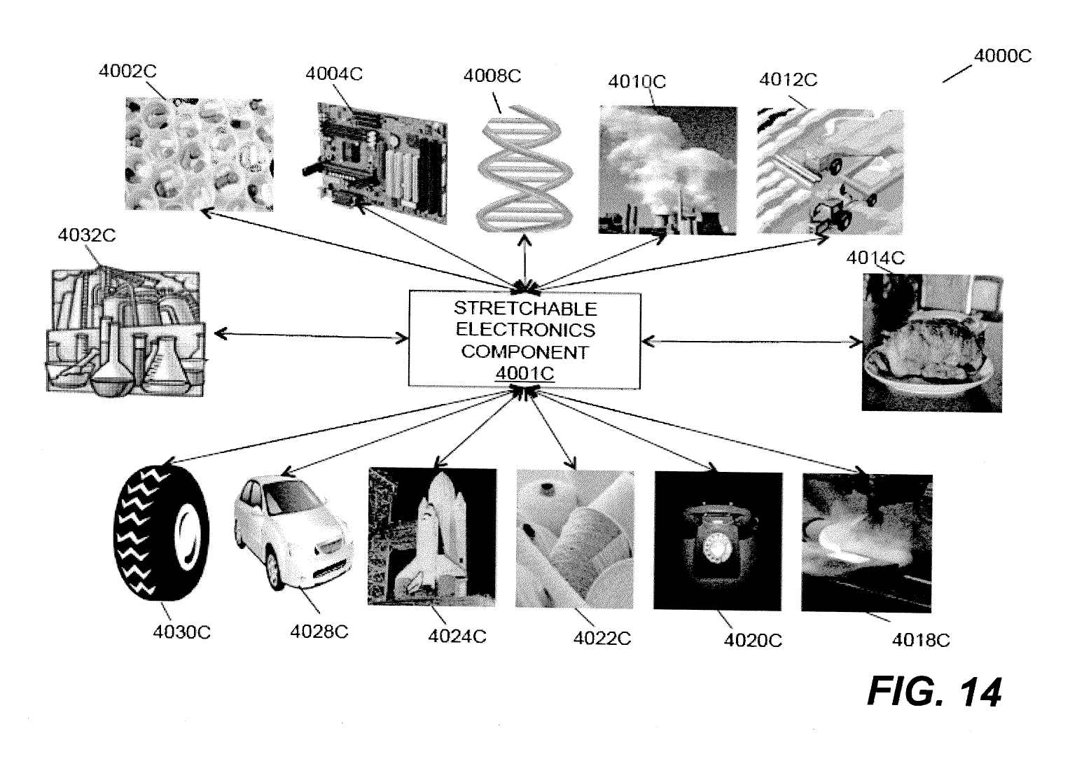

In embodiments, as illustrated in FIG. 14, a stretchable electronics component 4001C may be utilized to improve industrial products in the manufacturing industry involving diverse application fields such as pharmaceuticals 4002C, electronics fabrication and semiconductors 4004C, biotechnology 4008C, energy such as oil and gas 4010C, agribusiness 4012C, food processing 4014C, casting 4018C, telecommunications 4020C, textiles 4022C, aerospace 4024C, automotives 4028C, tire and rubber 4030C, chemicals 4032C and the like. The use of stretchable electronics component 4001C may create a stretchable electronics enabled product for use in manufacturing sectors as listed above without limitations. For instance, a manufacturing system or device may be designed with a stretchable electronics component 4001C such as embedded in a sensing sheet, electronic sheet, imaging array, discrete sensor and the like. Combined with a stretchable and/or flexible structure, the manufacturing system or device may transform into a stretchable and/or flexible electronics enabled manufacturing system or device, where the stretchable electronics component 4001C may deform in shape without degradation to functional performance of the overall manufacturing system or device. For example, a stretchable electronics component 4001C such as a stretchable electronics board may be flexed and/or deformed without harm to electrical integrity of the stretchable electronics board. The stretchable electronics component 4001C, therefore, enables an improvement to a manufacturing system or device by proving additional features.

In embodiments, stretchable electronics may facilitate surface monitoring of a structure surface such as surface of a mechanical component or a machine and the like or monitoring of a joint surface during assembly and integration or during construction in a manufacturing facility. In accordance with these embodiments, imaging, sensing, monitoring devices and layers having stretchable electronics component 4001C may be fitted or disposed on a surface like a joint during assembly and integration of multiple elements or during construction. This may enable the stretchable electronics component 4001C to deform in shape during severe environmental conditions such as shocks, vibrations, physical conditions and the like thereby preventing fragile devices like sensors from damage. Further, nano-stretchable electronics component 4001C may be disposed in the form of a thin layer that may deform to fill cracks thereby preventing further crack propagation and enhancing efficiency of a manufacturing facility such as those listed above without limitations and depicted in FIG. 14.

In accordance with various embodiments, the stretchable electronics component 4001C may be embedded with an imaging surface provided inside an assembly during assembly integration in a manufacturing facility. This may enable best fitting or fastening during integration of multiple assemblies such as manufacturing components and cutting machines. The stretchable electronics component 4001C may, in such a scenario, deform in shape to conform to corresponding fastening elements and fasteners and allow secured fastening. Further, the stretchable electronics component 4001C may be mounted on expansion joints for expansion monitoring. In the usual scenario, non-uniform exposure of expansion joints to heat may cause an uneven rate of expansion that may cause undesirable effects such as blisters, cracks, development of thermal stresses and the like thereby damaging conventional electronic components. Stretchable electronics enabled components fitted on or within expansion joints may be designed to deform and tolerate undesirable effects even after a prolonged uneven rate of heating. Such stretchable electronics enabled expansion joints may find application in areas such as aerospace 4024C for airplane joints and the like, automotives 4028C for vehicle joints and fittings and the like, energy sector 4010C for ducting and piping joints and the like without limitations.

Some components and especially at specific points may experience high impacts in certain application areas such as aerospace 4024C, automotives 4028C, energy sector 4010C and the like. These components may include without limitations landing gear of a plane, tires of a racing car, turbine blades, ultra-speed drill bits, tips of gear teeth and the like. Therefore, design and manufacturing of such components involving high impact points may require extremely sharp analysis and monitoring of forces and other parameters. Therefore, surface monitoring devices or layers or films that may be required in such cases may be embedded or disposed with stretchable electronics component 4001C that may tolerate high impacts and may deform based on physical and environmental conditions. Further, these high impact devices may be provided with stretchable electronics enabled sensing devices and layers for operations monitoring purposes as well. Therefore, in such cases, the stretchable electronics component 4001C may deform at high impact points on an application of heavy forces such as dynamic or sliding friction, rolling resistance, wheel spinning force and the like to counter the effect of high impacts. In addition, data storing devices mounted at high impact points may also utilize stretchable electronics component 4001C that may deform in shape under severe conditions for proper monitoring and data storing without failure.

In accordance with various embodiments, stretchable electronics component 4001C may be utilized in automated manufacturing environments to create a failure proof environment. In a conventional manufacturing environment, several electronics module may be used for monitoring, sensing, inspection and the like purposes. These electronics modules may be prone to severe conditions and fracture, crack or fail easily on account of the harsh conditions. Therefore, stretchable electronics enabled modules may be required that may be configured to deform in shape to tolerate severe manufacturing conditions. For example, these stretchable electronics component 4001C may be associated with tactile sensor arrays that may be mounted on a robotic vehicle/arm/linkage or mechanism and the like.

In an embodiment, the stretchable electronics component 4001C may be integrated with light emitting diode (LED) tapes that may be used for lighting various manufacturing facilities and locations within an architectural area such as door frames, cabinets, shelves, and the like or even machining chambers. The stretchable electronics component 4001C within LED tapes may deform in shape to fit varying requirements. For example, stretchable LED tapes may be extended to conform to the length of a door or may be compressed accordingly. Further, delicate lighting elements of stretchable LED tapes may be protected against any damages that may be caused by mishandling, excessive usage, harsh manufacturing environment and the like.

In embodiments, stretchable electronics component 4001C may be associated with semiconductor devices and components of an optical proximity sensor such as a photodiode, phototransistor and the like that may be utilized in a manufacturing environment during monitoring and inspection. This may provide stretchability and/or flexibility to the components of the optical proximity sensor thereby preventing it from damage. Further, the stretchable electronics component may deform to counter effects of over current and over voltage, thereby acting as an over current or over voltage sensing device.

In accordance with an embodiment, stretchable electronics component 4001B may be utilized in blast dosimeters that monitor and record data during a blast to identify intensity of the blast or explosion and various other related aspects. In addition, such blast dosimeters may be required for assisting in physiological monitoring and health care after an explosion. Blast dosimeters may be mounted in manufacturing facilities that may be prone to explosions and blasts such as chemical industry 4032C, pharmaceuticals 4002C, energy sector 4010C, aerospace 4028C and the like. In an embodiment, blast dosimeters may be fitted at separate locations of the manufacturing facility. In another embodiment, blast dosimeters may be fitted on various body parts or accessories worn by humans working in the manufacturing facility. For instance, a blast dosimeter may be fitted on a helmet of a worker or on the chest and the like. In such a scenario, blast dosimeters may monitor vital signs such as heart rate, body temperature, blood pressure, pulse and the like. Stretchable electronics enabled blast dosimeters may tolerate effects such as vibrations, shocks, temperature and pressure conditions and the like caused by the blast in the manufacturing environment by deforming the stretchable electronics component 4001C in a shape that counters blast effects. Therefore, blast dosimeters may not be defunct and fail after a blast occurs, thereby continuing monitoring of the manufacturing facility even after the blast.

In embodiments, stretchable electronics component 4001C may be mounted on solar operated devices such as solar lights and the like. Since solar operated devices may include delicate electronics components and panels that may be damaged inside a manufacturing environment with severe physical conditions, solar devices may be designed with stretchable electronics component 4001C. The stretchable electronics component 4001C may deform in shape to prevent solar devices from damage during harsh operating conditions. In accordance with various embodiments, the stretchable electronics component 4001C may be designed in various forms such as stretchable board, stretchable films, stretchable layers and the like without limitations.

In embodiments, the stretchable electronics component 4001C may be employed in sensors and/or other test devices for recording technical parameters of various devices and various operations inside a manufacturing facility. For example, test data sheets may be utilized to monitor and collect operational and functional parameters during manufacturing and testing of products. These data sheets may take the form of a delicate electronic layer, imaging layer, recording layer, discrete sensors and vision systems and the like. In an embodiment, the stretchable electronics component 4001C along with a transducer such as a load cell may be affixed in a device capable of recording parameters on a machining platform. The stretchable electronics component 4001C may be associated with the load cell, which may deform/stretch without affecting performance of the device. In another embodiment, test data sheets may be in the form of electronic stickers that may be attached to cutting machines in a machining chamber of the manufacturing environment. Stretchable components embedded within test sheets allow surface monitoring, health monitoring, operational and functional parameters monitoring of the devices without being defunct due to the stretchable and/or flexible character that may create deformation to counter the effect of external physical conditions.

A test datasheet may be an electronic display device embedded with stretchable electronics components/stretchable electronics boards. Such an electronic display device may be stretched/compressed to fit in a space for measurement and inspection. In this aspect, the stretchable electronics component 4001C may be flexible and stretchable to be attached at various locations and facilities of the manufacturing environment due to its shape.

Likewise stretchable electronics interfaces such as ports can be stretched for being affixed with corresponding mating parts. For example, an RS232 interface port may be fabricated using stretchable material and stretchable electronics components to form ports that may be altered by stretching to adjust and fit into their respective ports.

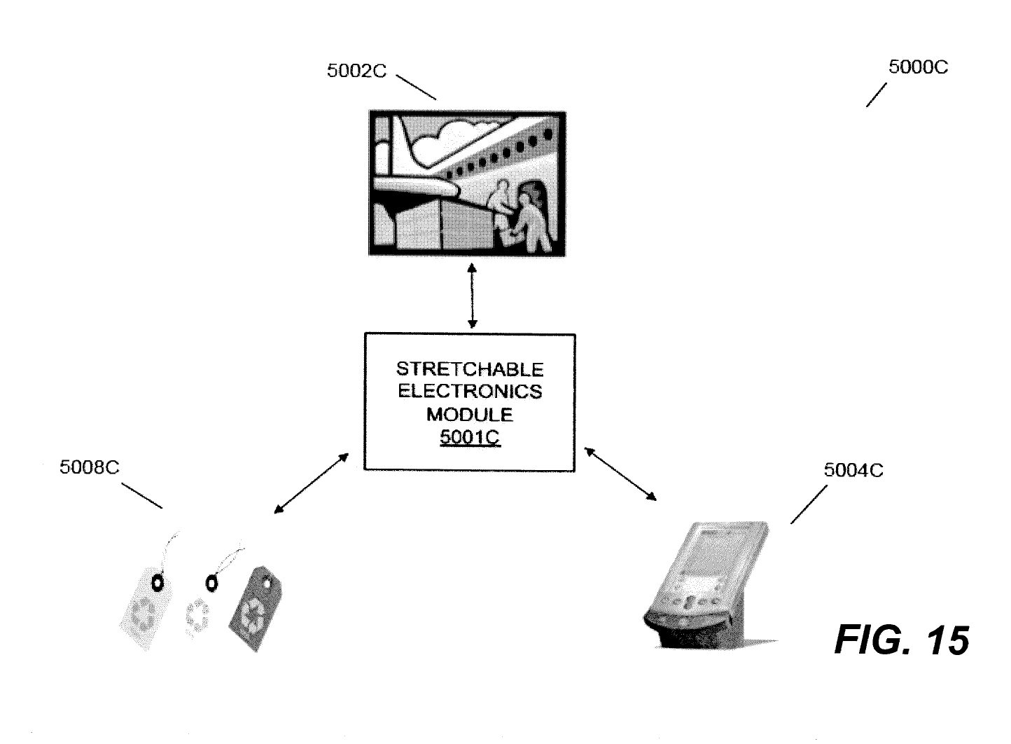

In embodiments, as illustrated in FIG. 15, a stretchable electronics module 5001C may be utilized to improve monitoring of shipment conditions/environment of a product 5002C; tracking shipments by using stretchable electronics module 5001C enabled devices such as a handheld monitor 5004C, an identity tag 5008C, and the like. For instance, the stretchable electronics module 5001C may be applied to monitor shipment conditions/environment of the product 5002C. In a scenario, the stretchable electronics module 5001C may be integrated with a surface of the product 5002C for collecting and/or storing data. Such a stretchable data collection facility may be integrated with a data collection sheet such as stretchable electronic stickers that may contour to the surface of the product 5002C. Further, the stretchable electronics module 5001C enabled data collection sheet may be tolerant to changes in surface during vibration, expansion, motion, and the like. Additionally, numerous sensors may be disposed on the stretchable electronics enabled data collection sheet that may collect data regarding environmental conditions such as temperature, humidity, and the like, related to shipment of the product 5002C. Furthermore, the stretchable electronics module 5001C enabled data collection sheet may deform to prevent damages caused due to mishandling of the product 5002C.

In a scenario, the stretchable electronics module 5001C such as a stretchable imaging array may be used as an imaging surface. The stretchable electronics enabled imaging array may provide data related to various parameters such as handling of the product 5002C, and the like. The stretchable imaging array may be designed to monitor surrounding environment such as in surveillance, product monitoring, and the like. In an example, conventional electronics may fail due to varying environmental conditions especially where the surface of the product 5002C may change in time, such as through vibrations, expansion, and the like. The stretchable electronics module 5001C may enable the imaging surface to be tolerant of harsh environmental conditions. In another example, stretchability of the imaging surface may allow production of very small cameras that may be laid on the surface of the product 5002C for procuring images of the shipment conditions.

In another scenario, the stretchable electronics module 5001C may be associated with a device such as the handheld monitor 5004C, that may enable tracking of shipments. The handheld monitor 5004C may be designed with a stretchable display, stretchable electronics board, and the like. Combined with a stretchable and/or flexible structure for the handheld monitor 5004C, the stretchable electronics module 5001C may enable the handheld monitor 5004C to be deformed in shape without degradation of functional performance. For example, the stretchable electronics module 5001C such as the stretchable electronic board for the handheld monitor 5004C may enable the handheld monitor 5004C to be flexed and/or deformed without harm to the electrical integrity of the stretchable electronics board. The stretchable electronics module 5001C may therefore enable an improvement to the handheld monitor 5004C, such as being able to fold up, to stretch and deform the handheld monitor, and the like.

In a similar manner, the stretchable electronics module 5001C may be integrated with an identity tag 5008C that may be used for tracking goods/containers during shipments. The identity tag 5008C may be a RFID tag that may be associated with the product 5002C for tracking the shipment thereof. For instance, the identity tag 5008C may be designed with a stretchable electronics module 5001C for being attached to the product 5002C. The stretchable electronics component 5001C may enable the identity tag 5008C to be flexed and/or deformed in shape without degradation of functional performance of the identity tag 5008C. Further, the stretchable electronics component 5001C may be used in identity tags of variable sizes without causing any damage to performance thereof. Further, the stretchable identity tag 5008C may be capable of tolerating damages caused thereto.

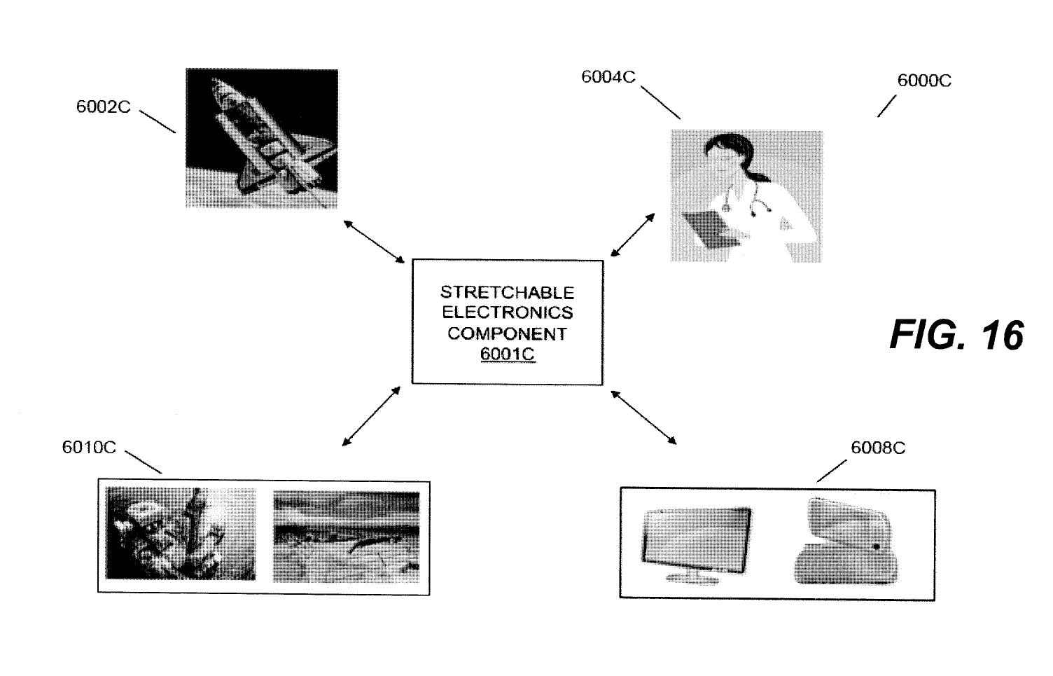

In embodiments, as illustrated in FIG. 16, a stretchable electronics component 6001C may find application in various industries such as aerospace industry 6002C, healthcare industry 6004C, electronics industry 6008C, oil and gas industry 6010C, and the like. For instance, the stretchable electronics component 6001C may be used in the form of a sheet that may be integrated with a data collection sheet, thus resulting in a stretchable data collection sheet. Such stretchable data sheets may be helpful in various research and development activities conducted by industries such as aerospace industry 6002C, healthcare industry 6004C, electronics industry 6008C, oil and gas industry 6010C, and the like. The stretchable electronics enabled data sheets may be attached to various parts that may be undergoing testing. The stretchable electronics component 6001C may protect data sheets from vibrations, shocks, and other damages.

In another scenario, the stretchable data sheets may be embedded with sensors for recording information regarding product conditions, testing conditions, and the like. For example, the stretchable data sheets may include image sensors for collecting data regarding the operational parameters of a product. Further, the stretchable electronics component 6001C may include a wireless communication module for transmitting the collected information to a computer. For example, in aerospace industry 6002C, the stretchable electronics component 6001C may be associated with a windshield, a black box, seats, landing gears, and the like. Specifically, the windshield may be configured with the stretchable electronics component 6001C such that the windshield may become a stretchable and/or flexible windshield. Such a stretchable windshield may be protected from damages such as cracks, and the like. In a similar scenario, the black box may include the stretchable electronics component 6001C for eliminating the loss of crucial information therefrom.

In the case of healthcare industry 6004C, the stretchable electronics component 6001C may be used in medical equipments such as wearable health monitors, and the like. The wearable health monitors may be integrated with physiological sensors. The physiological sensors may monitor and collect information regarding various conditions of a patient such as blood pressure, pulse rate, and the like. Further, the physiological sensors may wirelessly transmit the collected information to a healthcare server. The sensors may thereby timely indicate cases of medical emergencies. Furthermore, the stretchable electronics component 6001C embedded wearable health monitors may be varied in shape and size as per the requirements of patients. Also, health monitors may be deformed to conform to human body parts. The stretchable electronics component 6001C may therefore enable an improvement in medical equipments such as the wearable health monitors without harming electrical integrity of the medical equipment. In a scenario, the stretchable electronics component 6001C may be associated with various aspects of the electronics industry 6008C. For instance, the stretchable electronics component 6001C may be used as a stretchable display, stretchable electronics board, and the like, in mobile phones, liquid crystal displays (LCDs), and the like. Specifically, the stretchable electronics board may enable the mobile phone to be deformed in shape without harming the functional aspect of the mobile phone. Further, the stretchable electronics component 6001C may enable the LCDs, mobile phones, and the like to tolerate physical vibrations, shocks, and the like.

In another scenario, drilling machines may include the stretchable electronics component 6001C embedded in a drilling bit of the drilling machine. The stretchable electronics component 6001C may enable the drilling bit to tolerate the vibrations, shocks, and the like, and thereby protects the drilling bit from breaking down.

It must be understood by a person ordinarily skilled in the art that the stretchable electronics component 6001C may be utilized in various other industries apart from those mentioned above.

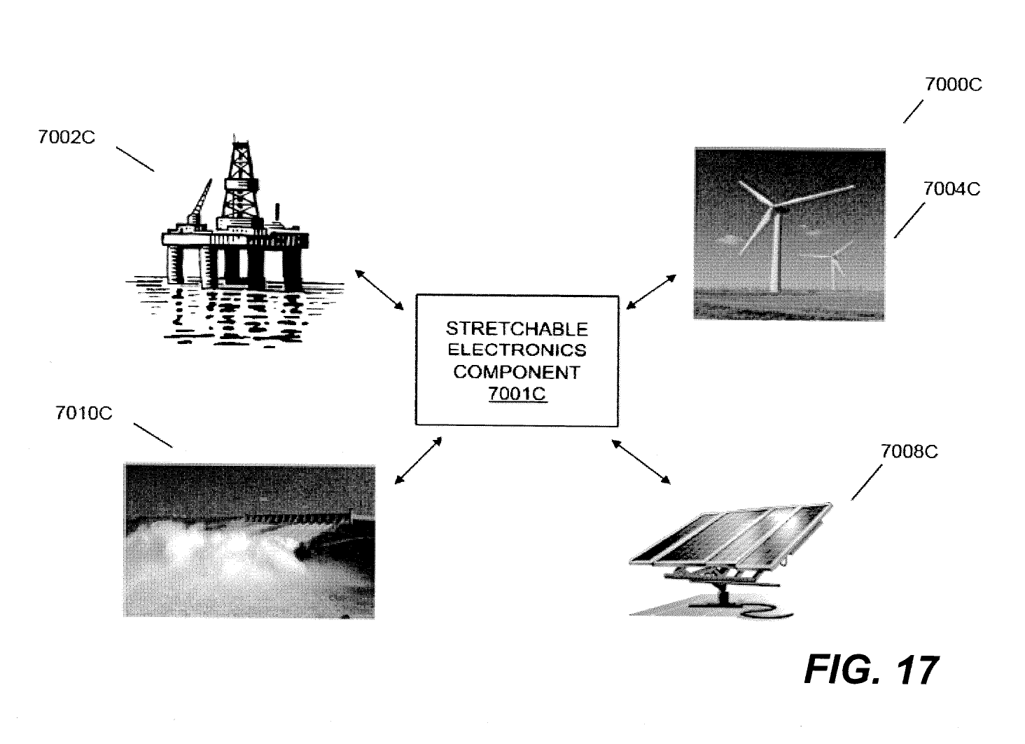

In embodiments as illustrated in FIG. 17, the stretchable electronics component 7001C may be integrated in various devices associated with energy production. For example, the stretchable electronics component 7001C may be a stretchable electronics board that may be embedded into devices utilized in exploration of oil and gas 7002C. Likewise, crude oil, which is a mixture of hydrocarbons such as methane, ethane and heavier hydrocarbons such as pentane may be detected using an electronic device fabricated using stretchable electronics component. Devices constructed with the stretchable electronics component 7001C may be compressed into a very small shape without compromising the functionality thereof. For example, in order to determine the proportion of various types of hydrocarbon in an oil field very small sensors may be required; these sensors may be fabricated using stretchable electronics component 7001C.

In an embodiment, the stretchable electronics component 7001C may be utilized in wind turbines 7004C. Since these devices are exposed to extreme pressure, devices fabricated with stretchable electronics component 7001C may offer advantages of being stretched when exposed to high wind pressure and may regain their original shape once these conditions disappear. In an embodiment, stretchable electronics may be integrated into various devices enabled to monitor wind speed, wind direction, moisture content and the like. Further, the stretchable electronic circuitry such as devices, components, modules, sensors and the like that may be stretchable may be utilized for assessing the structural strength of various parts of the wind turbine 7004C. For example, the self-powered stretchable electronic component may be utilized to determine the structural strength of the blades of the wind turbine 7004C. Similarly, the wear and tear of a wind turbine shaft may be evaluated based on a stretchable electronics component associated with it; the stretchable electronics component 7001C may stretch/deform or expand along with the wear and tear of the wind turbine shaft to transmit data about its structural strength.

The stretchable electronics component 7001C may be integrated into various solar generation modules such as solar collectors 7008C to record solar radiation. Usually, the thermal expansion of the solar collectors 7008C is too hot; in this regard, the stretchable electronics affixed to the solar collectors 7008C may deform or expand without affecting the functionality of the stretchable electronics component 7001C. In addition, devices with stretchable electronics component 7001C such as sensors, data aggregation modules may be located in turbines, generators that may be compressed/stretched to fit in a small space without affecting the functionality of the electronics. Likewise, the stretchable electronics may be employed in heat exchanges, valves, generators that may take advantages of their stretchability. Various stretchable electronics components such as sensors for sensing temperature, moisture, and wind speed may be utilized at various locations in a solar plant to make use of the flexibility and stretchability offered by them.

In embodiments, the stretchable electronics component 7001C may also be utilized in hydroelectric modules 7008C. Since the hydroelectric modules 7008C are exposed to extreme pressure, various devices may be fabricated with the stretchable electronics component 7001C that may offer advantages of being stretched, when exposed to high pressure. Further, the devices may regain their original shape once such conditions disappear. In an embodiment, stretchable electronics may be integrated into various monitoring devices for monitoring speed of water, pressure, and the like. Further, the stretchable electronics circuitry such as components, modules, sensors and the like may be stretchable for assessing the structural strength of the various parts of the water turbines, generators, and the like. For example, the stretchable electronics component 7001C may be incorporated in blades of the water turbine as a stretchable electronics sheet. The stretchable electronics susceptible to operate under higher pressures may bend/or stretch at higher pressures without affecting the operation of the equipment and therefore may prevent wear and tear of the blades of the water turbine when they come in contact with high speed water.

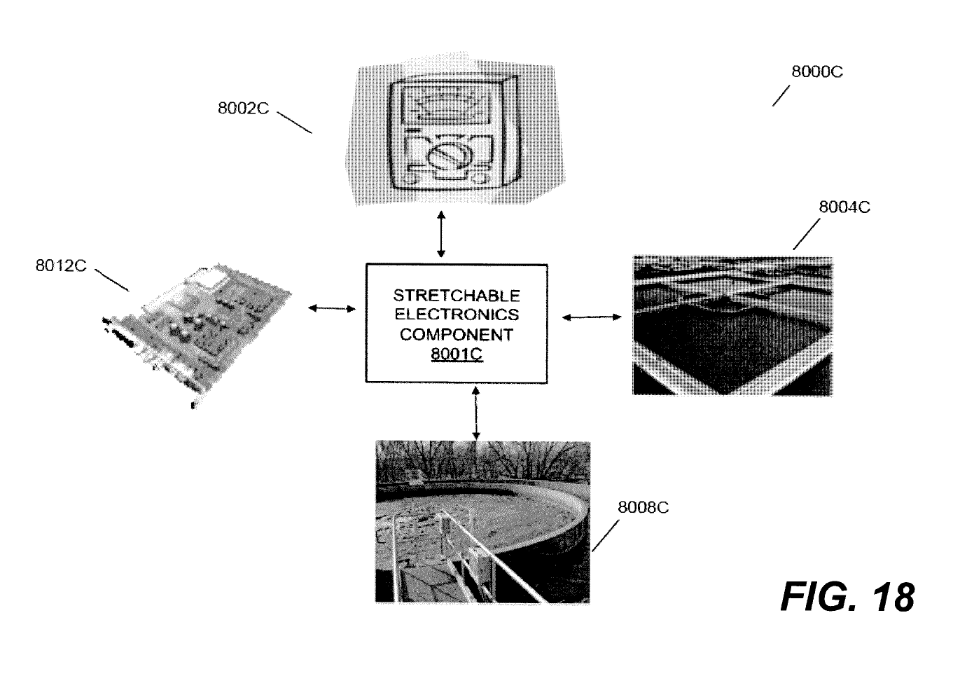

In embodiments, as illustrated in FIG. 18, a stretchable electronics component 8001C may be utilized with a monitoring device 8002C such as a gauge, a meter, and the like, for monitoring environmental conditions. For instance, the stretchable electronics component 8001C may be a stretchable electronics board that may be configured in the monitoring device 8002C. The monitoring device 8002C may collect information regarding various parameters such as humidity, heat, and the like, for monitoring the environmental conditions. In certain scenarios, the monitoring device 8002C may be used for monitoring various conditions during water treatment 8004C, wastewater treatment 8008C, and the like. For example, the water treatment plant 8004C may be equipped with monitoring device 8002C for collecting data such as data related to phosphate levels, presence of contaminants, and the like. The stretchable electronics component 8001C enabled monitoring device 8002C may be embedded with sensors for collecting the data. Further, the monitoring device 8002C may include a wireless communication module for communicating the collected data to a server.

In another scenario, the monitoring device 8002C may be an electronic board 8010C. The stretchable electronics component 8001C may enable the electronic board 8010C to be flexed and/or deformed without causing any damages to the mechanical and/or electrical structure. Further, combined with a stretchable and/or flexible structure for the monitoring device 8002C, the monitoring device 8002C may become a stretchable and/or flexible monitoring device 8002C. For example, if the monitoring device 8002C is exposed to varying temperatures, the electronic board 8010C may get damaged. Specifically, the electronics board 8010C may get expanded due to increase in temperature resulting in breaking up of various connections in electronic components. In a similar manner, the electronics board 8010C may also break down due to extremely low temperatures. In such cases, the stretchable electronics component 8001C may enable the electronics board 8010C to tolerate variations in temperatures by getting adapted as per the temperatures. In addition, the stretchable electronics component 8001C may enable the electronics board 8010C to tolerate any kinds on shocks, vibrations, and the like.

In accordance with the various embodiments, stretchable electronics component 8001C may find application in other environmental monitoring conditions such as remote sensing, and the like, without limiting the scope of the invention.

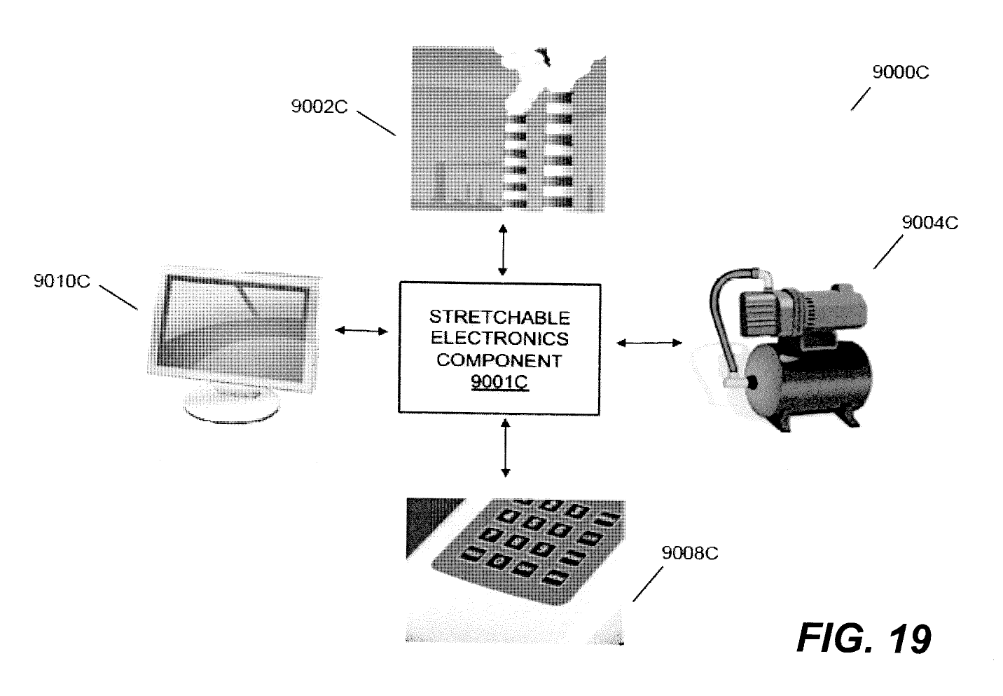

In embodiments, as illustrated in FIG. 19, a stretchable electronics component 9001C may be utilized to improve equipments used in a chemical processing plant 9002C such as feed pumps 9004C, controllers 9008C, and the like. For instance, the feed pumps 9004C may be designed with the stretchable electronics component 9001C such as a stretchable electronic board. The stretchable electronics component 9001C may deform in shape without degradation of functional performance of the feed pumps 9004C. Generally, the equipments used in the chemical processing plant 9002C may be exposed to harsh conditions such as high temperatures, mishandling, and the like. In a similar manner, various electronic units such as electronic sheets, and the like, that may be disposed on the equipments are exposed to the harsh conditions. As a result, the electronic units may get damaged.

In a scenario, the stretchable electronics component 9001C may be integrated with electronic sheets for collecting data regarding various parameters such as rate of flow of chemicals, temperature of chemicals, and the like. For example, as the feed pumps 9004C may get damaged due to high rate of flow, the stretchable electronics component 9001C may enable the electronic sheets to get accommodated as per the rate of flow and may prevent any damages to the feed pumps 9004C. Further, the electronic sheets may also be embedded with sensors such as temperature sensors, pressure sensors, and the like. These sensors may collect data regarding the temperature and pressure in the chemicals, and the like. Further, various other sensors for detecting any faults in machinery, release of toxic chemicals, reactivity data, and the like may be incorporated in the electronic sheet. In addition, the stretchable electronics component 9001C may prevent any electronic damage to the feed pumps 9004C that may be caused due vibrations, high temperature of chemicals, and the like.

In a scenario, a wireless communication module may be included in the electronic sheet such that the wireless communication module transmits the collected data to a monitor 9010C. The monitor 9010C may facilitate in monitoring safety conditions by means of the data sent from the various sensors. Further, various units may be mounted directly on machines for collecting a variety of data such as acceleration, velocity, temperature, and the like. The stretchable electronics component 9001C may be utilized with such units for enabling such units to be deformed in shape without degrading their functional performance. For example, the units may include stretchable electronics board that may allow the units to tolerate shocks, vibrations, and the like.

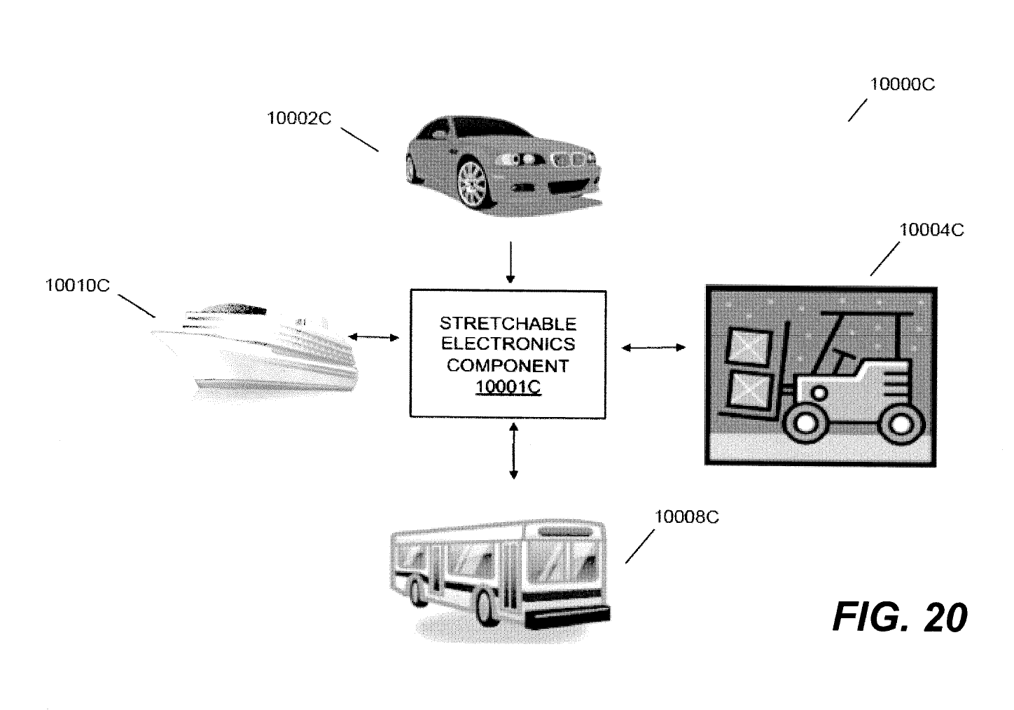

In embodiments, as illustrated in FIG. 20, a stretchable electronics module 10001C may be utilized to improve automotive products to create a stretchable electronics enabled automotive product for being used in an automobile 10002C, a forklift truck 10004C, a bus 10008C, a ship 10010C, and other transportation systems. Combined with a stretchable and/or flexible structure, the automotive products may transform into stretchable and/or flexible automotive products, where the stretchable electronics module 10001C may enable the automotive products to be deformed in shape without degradation to functional performance.

In a scenario, depending on the intended use of the automobiles 10002C, types of brake pads may also vary. For example, there may be different brake pads used for racing applications as compared to the ones used in normal usage. Further, operating temperature ranges may vary for various brake pads; for example, performance pads may not work efficiently when cold. Likewise, standard pads may fade under hard driving conditions. In such cases, the stretchable electronics module 10001C may be associated with brake pads of the automobiles 10002C such as a car, a jeep, and the like. The stretchable electronics susceptible to operate under higher temperatures may bend/expand/stretch at higher temperatures without affecting the operation of the brake pads.

In another scenario, the stretchable electronic module 10001C may be embedded in an electronic control unit that may detect various parameters such as temperature, speed, amount of fuel, ignition timing and other parameters that an engine needs to keep running Further, the electronic control unit may receive data related to engine speed, and the like, that may be calculated from signals coming from various sensing devices that may monitor the engine of the automobiles 10002C. For example, the stretchable electronics component 10001C may be an electronic board. Various sensors may be embedded on the stretchable electronics board. The stretchable electronics board may offer flexibility/stretchability under various conditions thus protecting the circuitry thereon. In accordance with various embodiments, the stretchable electronics module 10001C may be used with windshields, crankshafts, and the like. Further, the stretchable electronics module 10001C may enable the automobiles 10002C to tolerate vibrations, shocks, and the like.

In yet another scenario, the stretchable electronics module 10001C may be used with heavy equipments such as a forklift truck 10004C, a construction crane, and the like. The forklift truck 10004C may include a fork, a frame, an operating lever, and the like. Combined with a stretchable and/or flexible structure, components of the forklift truck 10004C may transform into stretchable and/or flexible components, where the stretchable electronics module 10001C may enable the components to be deformed in shape without degradation to functional performance. For example, the stretchable electronics module

C may be integrated into the fork such that the stretchable component may enable the fork to tolerate excessive stress and consequent heat without breaking down. However, the stretchable fork equipped with stretchable electronics may deform based on threshold levels of developed stresses to avoid fracture and failure of the fork.

In another scenario, a bus 10008C may be designed with a stretchable electronics module 10001C to form a stretchable component enabled tire, chassis, windshields, bonnets and the like. Combined with a stretchable and/or flexible structure, a component within a vehicle may transform into a stretchable component of the vehicle, where the stretchable electronics module 10001C may enable the vehicle such as the bus 10008C to deform in shape without degradation to functional performance. For example, the stretchable electronics module 10001C may be a stretchable electronics board that may enable the bus 10008C or a component therein to be flexed and/or deformed without harm to the electrical integrity of the stretchable electronics board.

Further, multiple imaging and sensing devices embedded with stretchable electronics module 10001C may be fitted with the bus 10008C that may record the vehicle health and transmit data to an information unit fitted within the bus 10008C. The imaging and sensing devices may deform in shape to conform to environmental conditions thereby preventing malfunction thereof. Additionally, stretchable components of the stretchable electronics enabled bus 10008C such as frame, wheel and the like may deform based on an external force exerted on the bus 10004C due to an accident or a mishap. The stretchable electronics module 10008C may deform to tolerate effects of the accident and prevent the bus 10008C from any damage.

In an embodiment, the stretchable electronics module 10001C may be utilized to improve modes of transportation to create a stretchable electronics enabled transport vehicle or any components therein, such as a hull of a boat or ship 10010C, landing gear of a plane, and the like. For instance, the hull of the boat 10010C may be designed with the stretchable electronics module 10001C such as a stretchable deck, stretchable girders, stretchable webs and the like. Combined with a stretchable and/or flexible structure, the hull may transform into a stretchable and/or flexible hull, where the stretchable electronics module 10001C may enable the hull to be deformed in shape without degradation to functional performance. For example, the stretchable electronics module 10001C may be a stretchable electronics board for the hull that may enable the hull to be flexed and/or deformed without harm to the electrical integrity of the stretchable electronics module 10001C.

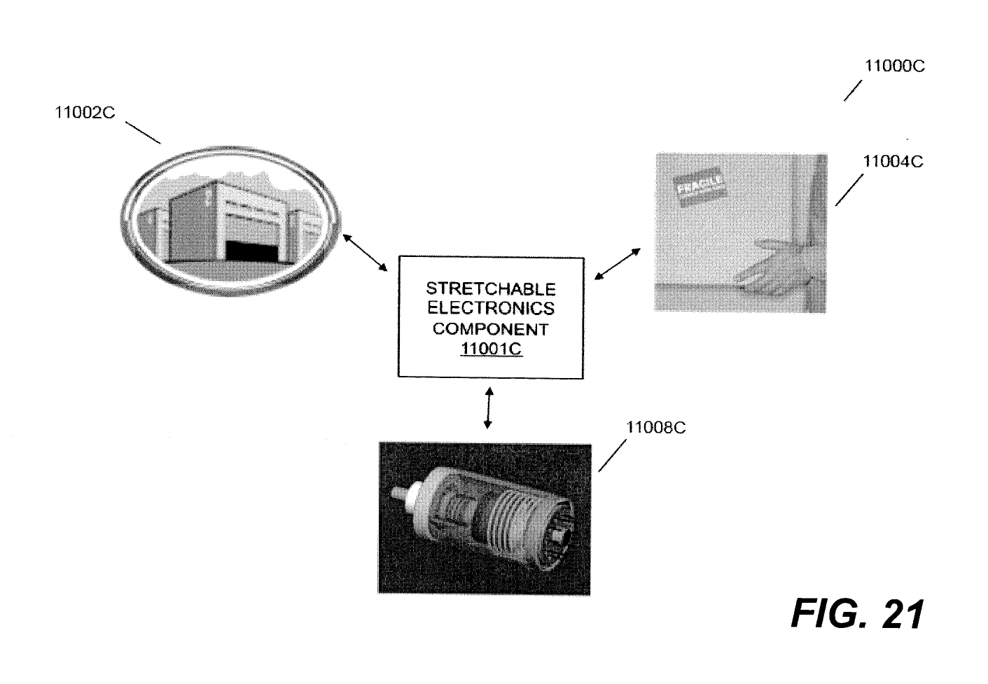

In embodiments, as illustrated in FIG. 21, a stretchable electronics component 11001C may be utilized to improve monitoring of storage conditions such as that of storage vessels, and the like. For instance, in a storage facility 11002C the stretchable electronics component 11001C may be utilized with imaging modules to create a stretchable electronics enabled imaging module such as a closed-circuit television (CCTV) camera 11004C, and the like. Further, the stretchable electronics component 11001C may include image sensors for recording any evidence of criminal activity. The stretchable electronics component 11001C may therefore monitor any space in the storage facility for preventing thefts. In addition, the stretchable electronics component 11001C may also be used as a stretchable electronics display in cameras of various sizes and shapes. For example, the CCTV camera 11002C may be configured to have a non-planar shape. In such cases, the stretchable electronics display may be stretched and adjusted as per the shape of the CCTV camera 11002C.

In a scenario, the stretchable electronics component 11001C may be integrated with product labels 11004C for creating stretchable electronics enabled product labels. Further, the product labels 11004C may be configured with sensors that may detect environmental conditions such as temperature, humidity, and the like, of the storage facility. For example, the product labels 11004C may be attached to temperature sensitive storage vessels before stacking the storage vessels in the storage facility 11002C. The temperature sensors configured on the product labels 11004C may detect variations in temperature if the temperature rises above a specified threshold. Furthermore, the sensors may communicate the collected data regarding the temperature to a remote server through a wireless communication module. The stretchable electronics component 11001C may therefore enable protection of temperature sensitive storage vessels.

In scenarios, the stretchable electronics component 11001C may be used in product labels 11004C of variable sizes without causing any damage to performance thereof. The stretchable electronics component 11001C may also enable improved tracking of storage vessels in the storage facility 11002C. Further, the stretchable product labels 11004C may deform to tolerate effects such as external scratches, rubbing and the like. Since a person handling the storage vessels may handle them roughly and the product labels 11004C may be prone to damage, the stretchable electronics component 11001C may deform to prevent damage caused by mishandling.

In another embodiment, the stretchable electronics component 11001C may be used in accelerometers 11008C. Generally, in industrial processes, materials are continuously fed from a supply vessel into a production line. The products may vary from a pharmaceutical, an explosive, a plastic, to any other product. However, the rate at which the materials are being transferred need to be controlled by means of an accelerometer 11008C, and the like. The accelerometer 11008C may be designed with the stretchable electronics component 11001C, such as a stretchable display, stretchable electronics board, and the like. Combined with a stretchable and/or flexible structure for the accelerometer 11008C, the accelerometer 11008C may become a stretchable and/or flexible accelerometer 11008C, where the stretchable electronics component 11001C may enable the accelerometer 11008C to deform in shape without degradation of functional performance.

In a similar scenario, the accelerometer 11008C may be mounted on a weight sensing device in accordance with an orientation of the weight sensing device. The stretchable electronics board may enable the accelerometer 11008C to conform with respect to the shape of the weight sensing device. Further, the stretchable electronics component 11001C may enable the accelerometer 11008C to tolerate vibrations, high speeds, shocks, and the like, without being damaged.

### CONCLUSION

All literature and similar material cited in this application, including, but not limited to, patents, patent applications, articles, books, treatises, and web pages, regardless of the format of such literature and similar materials, are expressly incorporated by reference in their entirety. In the event that one or more of the incorporated literature and similar materials differs from or contradicts this application, including but not limited to defined terms, term usage, described techniques, or the like, this application controls.

The section headings used herein are for organizational purposes only and are not to be construed as limiting the subject matter described in any way.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments of the invention can be implemented in any of numerous ways. For example, some embodiments may be implemented using hardware, software or a combination thereof. When any aspect of an embodiment is implemented at least in part in software, the software code can be executed on any suitable processor or collection of processors, whether provided in a single device or computer or distributed among multiple devices/computers.

In this respect, various aspects of the invention, may be embodied at least in part as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium or non-transitory medium) encoded with one or more programs that, when executed on one or more computers or other processors, perform methods that implement the various embodiments of the technology discussed above. The computer readable medium or media can be transportable, such that the program or programs stored thereon can be loaded onto one or more different computers or other processors to implement various aspects of the present technology as discussed above.

The terms “program” or “software” are used herein in a generic sense to refer to any type of computer code or set of computer-executable instructions that can be employed to program a computer or other processor to implement various aspects of the present technology as discussed above. Additionally, it should be appreciated that according to one aspect of this embodiment, one or more computer programs that when executed perform methods of the present technology need not reside on a single computer or processor, but may be distributed in a modular fashion amongst a number of different computers or processors to implement various aspects of the present technology.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, the technology described herein may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

1. A test data sheet for sensing at least one technical parameter associated with a component during manufacturing, testing, operation and/or use of the component, the test data sheet comprising:
a flexible and/or stretchable substrate to substantially conform to a surface of the component so as to facilitate significant proximity of the test data sheet to the surface of the component;
an adhesive disposed on at least a portion of the flexible and/or stretchable substrate to facilitate mechanical coupling of the test data sheet to the surface of the component; and
electronic circuitry disposed on, and/or formed or embedded in, the flexible and/or stretchable substrate, the electronic circuitry comprising:
at least one sensing element to sense the at least one technical parameter and generate at least one output signal based at least in part on the at least one sensed technical parameter;
a processor communicatively coupled to the at least one sensing element to receive and process the at least one output signal;
a memory communicatively coupled to the processor to store data relating to the at least one output signal; and
at least one power source to provide power to at least some of the electronic circuitry,
wherein the test data sheet is configured to deform in shape and/or size, in response to changes in physical conditions and/or environmental conditions associated with the surface of the component, without significant degradation to functional performance of the electronic circuitry.

2-60. (canceled)
